(19) United States
(12) Patent Application Publication
(10) Pub. No.: US 2026/0125540 A1
(43) Pub. Date: May 7, 2026

(54) Foamed Articles Of Manufacture Comprising Nanocellulose Elements

(71) Applicant: Soane Materials LLC, Miami, FL (US)

(72) Inventors: David S. SOANE, Coral Gables, FL (US); Delilah M. LUBARSKY, Miami, FL (US); Lauren G. DUKE, Miami, FL (US); Sydney Greenough HIGGINS, Miami, FL (US); Alexander V. SOANE, Coral Gables, FL (US)

(21) Appl. No.: 19/350,602

(22) Filed: Oct. 6, 2025

Related U.S. Application Data
(63) Continuation of application No. PCT/US24/23775, filed on Apr. 10, 2024.
(60) Provisional application No. 63/458,276, filed on Apr. 10, 2023.

(51) Int. Cl. C08L 1/02; C08J 9/28; C08L 93/04

(52) U.S. Cl. CPC C08L 1/02; C08J 9/283; C08L 93/04; C08J 2201/0504; C08J 2301/02; C08J 2393/04; C08J 2401/02; C08J 2401/28; C08J 2405/00; C08L 2203/14; C08L 2205/025; C08L 2205/035; C08L 2205/06; C08L 2205/16; C08L 2205/24

(57) ABSTRACT

The invention includes simple NCE-based materials comprising a simple NCE-based matrix, wherein the simple NCE-based matrix comprises a population of redispersible NCEs treated with a drying/dispersal additive; wherein the matrix provides an architectural framework for the simple NCE-based material; and wherein the simple NCE-based material comprises a barrier formulation. The invention also includes foamed composite NCE-containing materials comprising a composite NCE-containing matrix, wherein the composite NCE-containing matrix comprises a population of redispersible NCEs treated with a drying/dispersal additive, and an existing matrix; wherein the NCEs are integrated into the existing matrix, and wherein the existing matrix provides an architectural framework for the composite NCE-containing material; wherein the composite NCE-containing material comprises a barrier formulation. The invention further includes articles of manufacture, comprising the NCE-containing materials, formed articles made therefrom, and methods of their manufacture.

### RELATED APPLICATIONS

This application is a continuation of International Application No. PCT/US24/23775, which designated the United States and was filed on Apr. 10, 2024, published in English, which claims the benefit of U.S. Provisional Application 63/458,276, filed Apr. 10, 2023. The entire contents of the above applications are incorporated by reference herein.

### FIELD OF THE INVENTION

This application relates to formulations comprising nanocellulosic materials for use in forming foamed articles of manufacture.

### BACKGROUND OF THE INVENTION

Industrial foams are widely used in a number of commercial applications. Foaming a material provides it with certain mechanical properties such as shock absorbency, allowing foams to be used as containers, packaging materials, cushioning materials, low density structural materials, and wearable items for cushioning and impact protection. Foaming a material also improves its insulative properties, so that it can be used for thermal insulation and for thermally specialized articles of manufacture such as coolers and heat resistive or thermally insulative products. Foams can also provide acoustic insulation, preventing sound energy from traveling into or out of a designated region. Foaming minimizes costs by decreasing the amount of material needed to produce the desired effect, so that foams are particularly useful in situations in which light weight per unit volume is advantageous. Foams therefore are commonly used for containers or packaging materials such as wrappers, protective package inserts, space fillers like packing peanuts, in which the foamed material is used to envelop, encase, confine, or otherwise protect other items from external damage such as crushes, impacts, vibrations, extreme temperatures, and insect/animal intrusion.

Moreover, foams can be combined with additives that confer other properties on the foamed article, such as water or grease resistance. The additives can be integrated with or coat the foam to form special-purpose articles for which the additional properties are important. For example, containers in general, and containers for food and beverage products in particular, that are formed from foams in which appropriate additives can provide resistance to leakage, spills, absorption, contamination, and fluid incursion. As examples, food products can be contained securely in foamed cups, plates, dishes, trays, and the like, deriving mechanical protection from the foamed material itself along with affording a barrier to fluid ingress or egress. Such articles have been well received commercially: single-use food and beverage containers are ubiquitous, offering inexpensive, convenient, lightweight alternatives to reusable articles. Sanitary benefits of single-use containers have been associated with improved human hygiene and overall human health and well-being, in addition to their convenience.

These advantages come at a high environmental price. Foamed products are predominantly made from petroleum-derived plastics (e.g., polystyrene, expanded polystyrene, extruded polystyrene, polypropylene, polyethylene terephthalate, high-density and low-density polyethylene, polyurethane, polycarbonate). These petroleum-derived substrates produce foams that are lightweight, low cost, and resistant to oil and water vapor, such as expanded polystyrene (EPS, commonly sold under the brand name STYROFOAM™) and extruded polystyrene. The production of the petroleum-derived plastic itself requires the consumption of non-renewable resources and produces substantial greenhouse gas emissions. Processes for making certain foams, especially extruded foams, require considerable energy. Foams are also associated with ozone depletion and climate change, due to the use of toxic blowing agents such as chlorofluorocarbons and hydrofluorocarbons. Foams, especially polyurethane foams, are often synthesized and catalyzed with toxic and corrosive chemicals, such as isocyanate and strong acids, to form heavily crosslinked structures which drastically slow the degradation of the foam (and leads to little to no biodegradation).

Moreover, many of these articles made from foam are designed for single-use applications. However, conventional plastic-based foam products derived from petroleum are not biodegradable; thus, while they can be recycled under certain limited circumstances they are typically disposed of in landfills after a single use. These articles, once they reach a landfill, can take 450-1000 years—or more—to break down, yielding microplastic particles as they decompose. It is estimated that fewer than 1% of EPS cups are collected and recycled, while an estimated 500 billion such single-use cups are used worldwide every year and discarded. Moreover, single-use containers are often disposed of improperly, and undergo their lengthy decomposition in areas such as waterways, beaches, and alongside roadways, where they can come into contact with the aquatic or terrestrial animals in those local environments.

Concerns about the environmental impact of discarded and decomposing plastic articles have spurred manufacturers to consider bio-based alternatives. Materials composed in whole or in significant part of biological products or renewable agricultural materials or forestry materials, have been designated as “bio-based” by the USDA. Biopolymers derived from bio-based materials can be used to form bioplastic materials that offer alternatives to conventional, petroleum-derived plastics.

Biopolymers can be produced by biological systems (microorganisms, plants, animals) or chemically synthesized from biological materials such as proteins, starches, and sugars. The primary sources of biopolymers are renewable, such as agricultural feedstocks or waste products. Many biopolymers are biodegradable, which means that they are capable of decomposing into carbon dioxide, water, and other organic compounds via the enzymatic actions of microorganisms. Those bio-based plastics made from precursors such as such as polylactic acid (PLA), polyhydroxyalkanoates (PHAs), and cellulose are typically considered biodegradable, in that they can be decomposed in the environment by microorganisms under certain circumstances (such as, for example, high heat and long duration for PLA). Certain biodegradable materials are further deemed “compostable,” meaning that they can be degraded by microorganisms to form nutrient-rich organic material that is able to enrich the soil, yielding final products that are similar to those produced during natural composting.

While these bio-based plastic alternatives, for example polylactic acid plastics, starch-derived plastics or cellulose-based plastics, are of great interest as substrates for manufacturing plastic materials, their use in common consumer applications, e.g., as durable formed articles, containers and packaging, remains limited, in part due to performance limitations. These materials tend to be hydrophilic and/or lipophilic, having a high affinity for water and/or fats. Thus, these materials can become soggy or impregnated with grease, which makes them unsuitable as containers for foodstuffs and for other water- or oil-laden products. As water or oil penetrate the durable articles, they begin to solvate the containers or packaging materials, affecting their mechanical properties so that they are weakened structurally and predisposed to failure. These limitations of bio-based plastics have been resolved in many cases by coating the bioplastic materials with substances having strong hydrophobic and oleophobic properties, typically petroleum-derived organic substances such as polyethylene, polyethyleneimine, PVC, or fluorocarbons, materials that have a well-recognized impact on the environment. Furthermore, while such coatings improve the water and oil resistance in bio-based materials, such substances can still lack rigidity and mechanical strength. In addition, the conventional process for making foams from such materials is costly, in part because the formulations used for foaming contain large amounts of water that must be removed during processing.

To address these limitations, manufacturers have added inorganic and organic materials as particulate or fiber fillers to bio-based formulations in order to improve their mechanical properties and streamline their processing. Compared to those materials using inorganic fillers, alternative bioplastics that incorporate natural particles or fibers offer advantages of renewability, high strength, relatively easy processing, and other desirable properties. Nanoscale and microscale cellulosic fibers, such as nanofibrillated celluloses (NFCs), microfibrillated celluloses (MFCs), nanocrystalline celluloses (NCCs) and microcrystalline celluloses (MCCs) are particularly attractive fillers for improving strength. While these nanoscale and microscale cellulose fibers and crystals (collectively termed “nanocellulose elements,” “NC elements,” or “NCEs”) hold promise for use in biopolymeric products, there are restrictions. First of all, the NCE fibers themselves are hydrophilic, and thus do not contribute to the water resistance of a formed product. Water-repellent treatments are thus still necessary for articles that contain NCEs. More importantly, the NCEs need to be transported to where they will be used in highly diluted suspensions (<5-10 wt %) to prevent them from becoming entangled with each other. This entangling can lead to their consolidation into a dense, viscous mass that resists redispersion; if this tight network of aggregated cellulosic elements is further dewatered, it solidifies further, a process termed hornification. With complete drying of the NCE suspension, a solid bricklike mass is formed that is substantially undispersable. Therefore, in order to maintain a NCE suspension in a usable state so that the properties of the NCEs it contains are accessible for use in other materials, it must be maintained in a highly diluted form.

Despite a decade-long series of academic and industrial efforts, success in low-cost and effective drying and redispersion of NCEs has eluded commercial nanocellulose producers. The twin challenges of (a) drying or concentrating the aqueous media in which the NCEs are suspended and (b) subsequently redispersing them are caused by two factors: (1) the propensity of cellulose polymers in the NCEs to form hydrogen bonds with one another, adhering adjacent cellulosic elements into irreversible aggregates comprised of an assemblage of particles durably attached to each other that resist redispersion; and (2) the huge surface area per unit weight associated with the size and morphology of the NCE, greatly increasing exposure of the NCE surfaces to each other and exacerbating adhesion due to hydrogen bonding. These two factors combine to produce the hornification associated with concentrated and dried NCE suspensions. The tendency towards hornification in NCE suspensions requires that these substances be transported in a high volume of water, adding significantly to the costs associated with transporting and using them. Further, if a highly dilute NCE-containing suspension is used to form a foam, the excess water becomes incorporated in the foam and must be removed by a drying technique that permits NCEs to be dispersed evenly within the foam-forming matrix. While drying techniques such as freeze drying, spray drying, supercritical fluid drying and atomization, and the like, have been investigated by researchers, they have at best yielded small samples of redispersed NC elements, using processes whose high cost, energy requirements, and need for specialized equipment preclude their widespread adoption. This resistance to redispersion has impeded the adoption of NCEs as a matrix for forming a bio-based foam, and has further blocked the use of NCEs as an additive for other bio-based foaming materials.

There remains a need in the art, therefore, for methods and formulations that afford bio-based foam-based articles of manufacture a satisfactory degree of mechanical strength and water/oil resistance, so that they can offer commercially viable alternatives to petroleum-derived plastics for foamed articles of manufacture such as containers and packaging materials. To the extent that NCEs are to be integrated into bio-based foam-forming materials for such articles, there is a need to allow their commercial implementation at low cost, without excessive energy requirements, and without need for specialized equipment. To accomplish these latter goals, there remains an unmet need to render nanocellulose-containing formulations redispersible and resistant to hornification, so that these formulations can be transported economically and introduced into bio-based, foam-forming composites as a concentrate or as a dried particulate additive.

### SUMMARY OF THE INVENTION

Disclosed herein, in embodiments, are simple NCE-based materials comprising a simple NCE-based matrix, wherein the simple NCE-based matrix comprises a population of redispersed NCEs, wherein the simple NCE-based matrix provides an architectural framework for the simple NCE-based material, and wherein the simple NCE-based material is foamed. In embodiments, the simple NCE-based material comprises a plurality of submatrices. In embodiments, a pulp or a pulp-based substance is integrated into the simple NCE-based matrix; the simple NCE-based matrix can be pulp-dominant. In embodiments, the simple NCE-based material further comprises a foam-forming substance. In embodiments, the simple NCE-based matrix further comprises a reinforcement agent or a barrier formulation. In embodiments, the matrix comprises a reinforcement agent, which can comprise an additional amount of NCEs. In embodiments, the matrix comprises a barrier formulation that produces oleophobicity, which can comprise methylcellulose. In other embodiments, the matrix comprises a barrier formulation that produces hydrophobicity, which can comprise a resin acid or a combination of resin acids. Also disclosed herein are articles of manufacture comprising the simple NCE-based material described above. In embodiments, the article of manufacture further comprises a barrier formulation. In embodiments, the article is shaped into a formed article, which can be shaped as a plate or a bowl or a floating sheet or a floating particle.

Also disclosed herein are methods of manufacturing a simple NCE-based foamed material, comprising (a) providing a redispersed suspension comprising redispersed NC elements, wherein the redispersed suspension is produced by the substeps of (i) providing an initial NCE suspension comprising NC elements suspended in a liquid medium; (ii) adding a drying/dispersal additive to the initial NCE suspension to form a suspension of redispersible NCEs; (iii) drying the suspension of redispersible NCEs to produce a dried material comprising the redispersible NCEs; and (iv) suspending the dried material in a resuspending fluid to produce the redispersed suspension; (b) drying or concentrating the redispersed suspension to produce a simple NCE-based matrix, wherein the simple NCE-based matrix provides an architectural framework for the simple NCE-based material; (c) adding an additive substance before or after the step of drying or concentrating, thereby producing the simple NCE-based material; and (d) foaming at least one of the simple NCE-based matrix and the simple NCE-based material to produce the simple NCE-based foamed material. In embodiments, the simple NCE-based matrix comprises a plurality of submatrices. In embodiments, the additive substance is a bulking agent, which can comprise pulp or a pulp-based material. In embodiments, the additive substance is a barrier formulation that produces oleophobicity, and which can comprise methylcellulose. In embodiments, the additive substance is a barrier formulation that produces hydrophobicity, which can comprise a resin acid or a combination of resin acids. In embodiments, the step of foaming comprises exposing the simple NCE-based matrix to the action of at least one of a foam-forming substance and a foam-foaming process. In embodiments, the step of foaming comprises exposing the simple NCE-based material to the action of at least one of a foam-forming substance and a foam-forming process.

Further disclosed herein are composite NCE-containing materials comprising a composite NCE-containing matrices, wherein the composite NCE-containing matrix comprises a population of additive NCEs and an existing matrix, wherein the additive NCEs are integrated into the existing matrix, wherein the existing matrix provides an architectural framework for the composite NCE-containing material, and wherein the composite NCE-containing material is foamed. In embodiments, the existing matrix is bio-based. In embodiments, the composite NCE-containing material further comprises one or more additive substances, wherein each additive substance is selected from the group consisting of reinforcement agents, barrier formulations, and bulking agents. In embodiments, the composite NCE-containing material further comprises a foam-forming substance. Also disclosed herein are articles of manufacture comprising the composite NCE-containing material described above. The article of manufacture can be selected from the group consisting of packaging materials, insulators, athletic and personal protective articles, aquatic recreational articles, biobased floating articles, vehicles for delivery of an active agent, and containers.

In addition, disclosed herein are methods of manufacturing a composite NCE-containing foamed material, comprising: providing a population of additive NCEs and integrating the population into an existing matrix, thereby forming a composite NCE-containing matrix; adding an additive substance to the composite NCE-containing matrix, thereby producing a composite NCE-containing material; and foaming at least one of the composite NCE-containing matrix and the composite NCE-containing material to form the composite NCE-containing foamed material. In embodiments, the step of foaming comprises exposing the composite NCE-containing matrix to the action of at least one of a foam-forming substance and a foam-foaming process. In embodiments, the step of foaming comprises exposing the composite NCE-containing material to the action of at least one of a foam-forming substance and a foam-foaming process.

In yet other embodiments, simple NCE-based materials are disclosed herein comprising a simple NCE-based matrix, wherein the simple NCE-based matrix comprises a population of redispersible NCEs treated with a drying/dispersal additive comprising a lower critical solution temperature (LCST) polymer; wherein the simple NCE-based matrix provides an architectural framework for the simple NCE-based material; wherein the simple NCE-based material comprises a barrier formulation or a barrier substance; and wherein the simple NCE-based material is foamed. In embodiments, the barrier formulation comprises a substance selected from the group consisting of cellulosic polymers, lipids, proteins, fillers, fatty acids, a resin acid, and combinations of resin acids. In certain aspects, the NCE-based material comprises a barrier substance and the barrier substance is selected from the group consisting of cellulosic polymers, lipids, proteins, fillers, fatty acids, a resin acid, and combinations of resin acids. In certain embodiments, the barrier formulation comprises an oleophobic substance selected from the group consisting of MC, HPMC, CMC, NaCMC, CA, CAB, chitosan, rosin, lignin, and a vegetable protein; in other embodiments, the barrier formulation comprises a hydrophobic substance selected from the group consisting of MC, CA, CAB, chitosan, rosin, hydrophobized starch, lignin, and a vegetable protein. In certain additional embodiments, the barrier substance is an oleophobic substance selected from the group consisting of MC, HPMC, CMC, NaCMC, CA, CAB, chitosan, rosin, lignin, and a vegetable protein; in other embodiments, the barrier substance is a hydrophobic substance selected from the group consisting of MC, CA, CAB, chitosan, rosin, hydrophobized starch, lignin, and a vegetable protein. In embodiments, the simple NCE-based material further comprises one or more additive substances selected from the group consisting of a bulking agent, a reinforcement agent, a nucleation agent, a plasticizer, a thickener, and an appearance-modifying agent, or a combination thereof. In embodiments, the one or more additive substances is a bulking agent, which can comprise pulp or a pulp-based substance, or which can comprise filler particles, which filler particles can comprise plant-derived organic materials. In embodiments, the one or more additive substances is a nucleation agent. In embodiments, the one or more additive is a plasticizer, which can be selected from the group consisting of glycerol, triglycerin, triacetin, triethyl citrate, acetyl triethyl citrate, tributyl citrate, oleic acid, levulinic acid, PEG, and polysorbate. In embodiments, the one or more additive substances is a thickener, which can be selected from the group consisting of xanthan gum, guar gum, agar gum, welan gum, gellan gum, MC, CMC, and HPMC. In embodiments, the simple NCE-based material further comprises a foam-forming substance. In addition, articles of manufacture comprising these simple NCE-based materials are disclosed herein, which can be shaped as a formed article, such as one shaped as a plate, a bowl, a floating sheet, or a floating particle.

Also disclosed herein, in embodiments, are methods of manufacturing a foamed article comprising a simple NCE-based material, comprising: (a) producing a simple NCE-based material comprising redispersible NC elements, wherein the simple NCE-based material is produced by the substeps of: (i) providing an initial suspension comprising NC elements suspended in a fluid medium; (ii) combining a drying/dispersal additive with the initial suspension to form a suspension of redispersible NCEs; and (iii) adding an additive substance to the suspension of redispersible NCEs, thereby forming the simple NCE-based material; (b) exposing the simple NCE-based material to the action of a foam-forming substance or a foam-forming process to provide a foamed simple NCE-based material; and (c) forming or shaping the foamed simple NCE-based material into a desired configuration, thereby manufacturing the foamed article. In certain embodiments, the additive substance is selected from the group consisting of a barrier formulation, a barrier substance, a bulking agent, a reinforcement agent, a nucleation agent, a plasticizer, a thickener, and an appearance-modifying agent, or a combination thereof. In embodiments, the step of forming or shaping comprises extrusion.

Further disclosed herein, in embodiments, are foamed composite NCE-containing materials comprising a composite NCE-containing matrix, wherein the composite NCE-containing matrix comprises a population of redispersible NCEs treated with a drying/dispersal additive comprising a lower critical solution temperature (LCST) polymer, and an existing matrix; wherein the redispersible NCEs are integrated into the existing matrix, and wherein the existing matrix provides an architectural framework for the composite NCE-containing material; wherein the composite NCE-containing material comprises a barrier formulation or a barrier substance; and wherein at least one of the composite NCE-containing matrix, the existing matrix, or the composite NCE material is exposed to a foam-forming formulation or a foam-forming process whereby the composite NCE-containing material is transformed into a foamed composite NCE-containing material. In embodiments, the existing matrix comprises a bio-based polymer, which can comprise a cellulose derivative. In embodiments, the existing matrix comprises a petroleum-derived polymer, which can be derived from a plastic material that has been recycled. In embodiments, the barrier formulation comprises a substance selected from the group consisting of cellulosic polymers, lipids, proteins, fillers, fatty acids, a resin acid, and combinations of resin acids. In certain aspects, the NCE-containing material comprises a barrier substance and the barrier substance is selected from the group consisting of cellulosic polymers, lipids, proteins, fillers, fatty acids, a resin acid, and combinations of resin acids. In certain embodiments, the barrier formulation comprises an oleophobic substance selected from the group consisting of MC, HPMC, CMC, NaCMC, CA, CAB, chitosan, rosin, lignin, and a vegetable protein; in other embodiments, the barrier formulation comprises a hydrophobic substance selected from the group consisting of MC, CA, CAB, chitosan, rosin, hydrophobized starch, lignin, and a vegetable protein. In certain additional embodiments, the barrier substance is an oleophobic substance selected from the group consisting of MC, HPMC, CMC, NaCMC, CA, CAB, chitosan, rosin, lignin, and a vegetable protein; in other embodiments, the barrier substance is a hydrophobic substance selected from the group consisting of MC, CA, CAB, chitosan, rosin, hydrophobized starch, lignin, and a vegetable protein. In embodiments, the composite NCE-containing material further comprises one or more additive substances selected from the group consisting of a bulking agent, a reinforcement agent, a nucleation agent, a plasticizer, a thickener, and an appearance-modifying agent. In embodiments, the one or more additive substances is a bulking agent, which can comprise pulp or a pulp-based substance, or which can comprise filler particles, which filler particles can comprise plant-derived organic materials. In embodiments, the one or more additive substances is a nucleation agent. In embodiments, the one or more additive substances is a plasticizer, which can be selected from the group consisting of glycerol, triglycerin, triacetin, triethyl citrate, acetyl triethyl citrate, tributyl citrate, oleic acid, levulinic acid, PEG, and polysorbate. In embodiments, the one or more additive substances is a thickener, which can be selected from the group consisting of xanthan gum, guar gum, agar gum, welan gum, gellan gum, MC, CMC, and HPMC. In embodiments, the foamed composite NCE-containing material further comprises a foam-forming substance. In addition, articles of manufacture comprising these foamed composite NCE-containing materials are disclosed herein, which can be shaped as a formed article, such as one shaped as a plate, a bowl, a floating sheet, or a floating particle.

Also disclosed herein, in embodiments, are methods of manufacturing a formed article comprising a foamed composite NCE-containing material, comprising (a) providing a composite NCE-containing material comprising redispersible NC elements, wherein the composite NCE-containing material is produced by the substeps of: (i) providing an initial suspension comprising NC elements suspended in a fluid medium; (ii) combining a drying/dispersal additive with the initial suspension to form a suspension of redispersible NCEs; (iii) integrating the suspension of redispersible NCEs into an existing matrix, thereby forming a composite NCE-containing matrix; (iv) adding an additive substance to at least one of the initial suspension, the suspension of redispersible NCEs, the existing matrix, and the composite NCE-containing matrix, thereby forming the composite NCE-containing material; (b) exposing at least one of the initial suspension, the suspension of redispersible NCE, the existing matrix, and the composite NCE-containing matrix to a foam-forming formulation or a foam-forming process sufficiently to transform the composite NCE-containing material into a foamed composite NCE-containing material; and (c) forming or shaping the foamed composite NCE-containing material into a desired configuration, thereby manufacturing the formed article. In embodiments, the additive substance is selected from the group consisting of a barrier formulation, a bulking agent, a reinforcement agent, a nucleation agent, a plasticizer, a thickener, and an appearance-modifying agent. In embodiments, the step of exposing exposes at least one of the initial suspension, the existing matrix, and the composite NCE-containing matrix to a foam-forming process. In embodiments, the step of forming or shaping comprises extrusion.

### BRIEF DESCRIPTION OF THE FIGURES

FIG. 1 is a block diagram showing a process for producing matrices comprising redispersed nanocellulose elements.

FIG. 2 is a block diagram showing a process for producing matrices comprising redispersed nanocellulose elements.

FIG. 3 is a block diagram showing a process for producing matrices comprising redispersed nanocellulose elements.

FIG. 4 is a block diagram showing a process for producing foamed materials comprising redispersed nanocellulose elements.

### DETAILED DESCRIPTION OF THE INVENTION

### 1. Components of Redispersible Nanocellulose Elements Formulations

a. Redispersible Nanocellulose Elements Generally

It has been unexpectedly discovered that nanocellulose elements (NCEs) can be treated so that they can be redispersed in formulations for producing useful articles of manufacture, using formulations and methods as set forth herein and as set forth in U.S. Pat. App. Publication No. 20220412010A1 (U.S. patent application Ser. No. 17/834,521 filed Jun. 7, 2022; the '521 Application), the contents of which are incorporated by reference herein in their entirety. Using these inventive methods, formulations containing NCEs can be prepared that can be concentrated or dried and then redispersed without hornification. Such formulations comprising redispersed NCEs can then be employed for producing foamed materials, which can then be used for the manufacture of useful articles. The formulations themselves can be dried and formed to produce articles of manufacture, or the formulations can be integrated into existing matrices to form composites having improved properties vs the existing matrix itself or that have additional properties not present in the existing matrix.

Substrates suitable for treatment with the systems and methods disclosed herein (i.e., NFCs and MFCs, and NCCs and MCCs, collectively NCEs) can be derived from all types of cellulosic raw materials, in particular from plant-derived cellulosic raw materials. Plant-derived cellulosic raw materials comprise lignocellulosic materials: lignocellulosic materials are comprised of cellulose polymers bound together with varying amounts of lignin. Lignocellulosic materials of all kinds are suitable for producing NCEs or other lignocellulosic materials such as pulp. Plants having use as lignocellulosic materials can be woody (such as trees, with firm stems, and with multiyear growth cycles) or non-woody, having weak stems and annual or limited multiyear growth cycles. Lignocellulosic materials can include specialty-purpose crops such as switchgrass and elephant grass cultivated for uses such as biofuels, capable of multiple harvests. Materials useful for producing pulp can be derived, without limitation, from industries such as agriculture (e.g., corn stover and corncobs, sugarcane bagasse, straw, oil palm empty fruit bunch, pineapple leaf, apple stem, coir fiber, mulberry bark, rice hulls, bean hulls, soybean hulls (or “soyhulls”), cotton linters, blue agave waste, North African glass, banana pseudo stem residue, groundnut shells, pistachio nut shells, grape pomace, shea nut shell, passion fruit peels, fique fiber waste, sago seed shells, kelp waste, juncus plant stems, and the like), or forestry (saw mill and paper mill discards).

In embodiments, NCEs are conventionally produced from precursor lignocellulosic materials or other plant-derived cellulosic raw materials by a series of mechanical and/or chemical procedures performed in an aqueous medium, wherein the aqueous suspension loosens cellulose's interfibrillar hydrogen bonding to facilitate delamination, resulting in the formation of the NCEs. NFCs and MFCs are extracted from plant matter by different techniques from each other, so that their morphologies and properties are different. NFCs and MFCs can be distinguished from each other based on their size and shape: cellulose nanofibers are much smaller in diameter than cellulose microfibers and can be straight and rod-like, while cellulose microfibers are larger in diameter, more flexible, and more varied and irregular in appearance. While the literature cites a range of dimensions for NFCs and MFCs, NFCs fibers are nanoscale (for example, having a diameter between 4-20 nm), while MFCs can be much larger, though typically still having diameters in the nano-range, for example 20-100 nm or larger. After the NCEs have been formed from the precursor cellulosic material, the NCEs are dispersed in the aqueous medium at a low concentration (<10 wt %) because their high water-absorption capacity and tendency for hydrogen bonding cause them to form a highly viscous suspension even at low solid concentrations due to the hydrogen-bond-driven entangling of the high-aspect-ratio NC elements, as described above.

Additives have been discovered, as described in the '521 Application, that can be used to prepare NCEs so that they are redispersible after being formulated in solutions. Such additives are termed “drying/dispersal additives” herein. Without being bound by theory, these additives function to inhibit or disrupt that hydrogen bonding of the NCEs with each other at specific, usually elevated reaction temperatures, thus preventing consolidation and hornification, while retaining their high intrinsic hydrophilicity that allows facile redispersion in aqueous media. As used herein, the term “redispersion” and its grammatical derivatives and congeners refers to a process by which dried or concentrated NCEs prepared to be redispersible as described herein are suspended in a fluid medium (whether aqueous or non-aqueous), termed a resuspending fluid, so that there is a substantially complete dissolution of the dried or concentrated suspension of NCEs to release its NCE components as resuspended in the resuspending fluid. In embodiments, aqueous resuspending fluids can be used; in other embodiments, non-aqueous resuspending fluids can be used, such as fluids having hydrophobic properties or amphiphilic properties.

As used herein, the term “redispersible” refers to those NCEs that have been treated with a drying/dispersal additive as disclosed herein, which treatment renders the NCEs capable of redispersion. Formulations containing such redispersible NCEs can exist in a liquid, dried, or partially-dried state. In a fully dried or partially dried state, the NCEs in the formulation are capable of redispersion by suspending them in a resuspending fluid. Redispersible NCEs (i.e., NCEs treated with drying/dispersal additives as disclosed herein) can be contained in liquid formulations before they are dried; the presence of the drying/dispersal additives renders such NCEs redispersible so that they can undergo subsequent redispersion if they are dried or concentrated. Redispersible NCEs also exist in liquids formed by adding a resuspending fluid to a dried or concentrated formulation containing the redispersible NCEs; their presence as resuspended in such a liquid demonstrates that they are, in fact, capable of redispersion and are thus redispersible. For the avoidance of doubt, this last group of redispersible NCEs, which are by definition formulated to be redispersible and have been resuspended in a resuspending fluid that renders them in fact redispersed, can also be termed, more specifically, “redispersed NCEs”; all redispersed NFCs are, by definition, redispersible, but not all redispersible NFCs are redispersed.

In embodiments, redispersion results in a suspension of the NCEs so that they are formed as individual NCEs or amorphous coalescences of individual NCEs (either being referred to herein as “resuspended particles”), wherein such resuspended particles have an aspect ratio of greater than 10. In embodiments, the resuspended particles have an aspect ratio between about 10 and about 300, or between about 10 and about 200. In embodiments, the resuspended particles have an aspect ratio between about 50 and about 150. In embodiments, the resuspended particles have an aspect ratio between about 25 and about 75. In other embodiments, the resuspended particles have an aspect ratio between about 75 and about 125.

These formulations and methods include several different categories of drying/dispersal additives: (1) certain temperature-responsive polymers that can introduce spacing between NC elements during drying, thus preventing their clumping; (2) certain volatile small molecules that can create space between NC elements during drying; and (3) certain nonvolatile small or large molecules (“blocking agents”) that hinder hydrogen bonding between or among NC elements during drying. Drying/dispersal additives comprise, without limitation, temperature-responsive polymers, small molecule additives in volatile systems, and blocking agents. All of these materials act to disrupt hydrogen bonding at elevated temperatures or under other circumstances, while creating gaps between or among the NC elements with further drying that will permit subsequent redispersion.

While certain additives (for example, certain LCST polymers, as described below) are suitable for use as single agents for facilitating drying and redispersion, other additives lend themselves for use as adjuvants in combination with a main drying/dispersal additive, either when administered into the initial NC suspension simultaneously with the main additive, or when administered as pre-treatment to the initial NC suspension or any precursor thereof before adding the main additive, or when administered as a post-treatment to the initial NC suspension following the addition of the main drying/dispersal additive.

b. Drying/Dispersal Additives

It is understood that the drying/dispersal additives disclosed herein can be introduced into the initial NCE-containing suspension individually or in combination to improve the drying process for the NCEs and to facilitate their redispersion. Drying/dispersal additives can also be used in combination with other agents that enhance their efficacy, even if those other agents are not effective as drying/dispersal additives when used alone; such agents, used in combination with the drying/dispersal additives to enhance their efficacy, are termed “adjuvants.” It is further understood that one or more of the drying/dispersal additives and/or adjuvants can act together in a synergistic manner. Moreover, combinations of the drying/dispersal additives can be introduced sequentially during the preparation of the initial NC suspension, and/or before, after, or during the processes that are employed to produce the initial NC suspension from a feedstock of cellulosic sources, with or without the addition of adjuvants. For example, non-polymeric additives can be added during the processes that are employed to produce the initial NC suspension from feedstock, but desirably are to be added after chemical pretreatment of the initial NCEs that are derived from the cellulosic or lignocellulosic precursor material.

i. Temperature-Responsive Polymers

In embodiments, certain temperature-responsive polymers can be employed to create space between the NC elements during drying, thereby preventing the NC elements from aggregating during the drying process. By preventing the dense aggregation and consolidation of the NCEs, the temperature-responsive polymer allows them to be redispersed upon contact with the resuspending fluid. Temperature-responsive polymers especially suitable for this purpose are those that exhibit a phenomenon known as LCST (lower critical solution temperature) phase behavior. It is understood that certain LCST polymers are hydrophilic below their LCST transition temperature and become reversibly hydrophobic above their LCST transition temperatures. In other words, below the LCST point the polymer shows high affinity towards water, consistent with its intrinsic molecular hydrophilicity. However, above the LCST point, the polymer repels water and shuns hydrogen bonding. This is evidenced by the observed thermogelation of polymer solutions above this transition temperature. As the polymeric or oligomeric LCST additive self-assembles on the surface of the NC elements (in the form of mono-layer or a few molecular layers), drying of NC elements and the resulting morphology of the NC-containing material the dried state are affected so that the ultimate redispersion of such NCEs is facilitated.

For use in this setting, the LCST polymer can be added to the initial NC suspension at a temperature below the LCST polymer's transition temperature. The initial NC suspension is then heated to effect its drying. As water evaporates from the initial NC suspension during drying, its temperature rises and approaches the boiling point of water, coming to exceed the LCST polymer's transition temperature, at which point the LCST polymer loses its hydrophilic character and becomes hydrophobic. When it becomes hydrophobic, the LCST polymer's behavior changes: at that point it interferes with the hydrogen bonds that would be forming between the NC elements. The hydrophobic nature of the LCST polymer now drives the aggregation or disaggregation of the NC elements, instead of these processes being driven by the interaction of the hydrophilic cellulosic units of the NC elements.

In embodiments, selected LCST polymers can markedly or completely hinder the dense aggregation and consolidation of NC elements upon drying. In embodiments, the ability of selected LCST polymers to disrupt dense aggregation and consolidation of NC elements is independent of equipment selection and manner of drying. For example, the suspension containing the LCST polymer and the NC elements can be left quiescent during drying. A wide range of drying temperatures and pressures can be applied to the initial NC suspension in the presence of selected LCST polymers to accomplish aggregate-free drying. Dried NC materials that incorporate selected LCST polymers as described herein can be readily redispersed in water with gentle agitation or stirring, with minimal or no clotting or residual dense aggregations or consolidations identified in the redispersed suspension. These features allow for a wide latitude in parameters for redispersion and for processing the redispersed material.

In embodiments, the list below offers examples of LCST polymers and their analog short-chain oligomers that can be used as drying/dispersal additives to prevent dense aggregation and consolidation, and thereby to facilitate subsequent redispersion of NC elements.
Methyl cellulose
Carboxymethyl cellulose
Sodium carboxymethyl cellulose
Hydroxylethyl cellulose
Hydroxypropyl cellulose
Hydroxypropylmethyl cellulose
Ethylhydroxyethyl cellulose
Polyvinylcaprolactam
Poly(methyl vinyl ether)
Poly(N-isopropylacrylamide)
Poly(N,N-diethylacrylamide)
Block copolymer of poly(ethylene oxide) and poly(propylene oxide)
Poly(pentapeptide) of elastin

Note that thermogelation temperature of certain of the additives listed above depends on the type and degree of substitution and is tunable by structural design. Advantageously, a selected LCST polymer for use as a drying/dispersion additive can have a transition temperature that is greater than the ambient temperature (for example, >25° C.), so that the polymer remains in solution until the drying step commences.

ii. Volatile Small-Molecule Additive Systems

In embodiments, volatile systems comprising small molecule additives can be employed alone or in combination with other additives to act as drying/dispersal additives by creating space between the NC elements during drying and thereby preventing the NC elements from aggregating during the drying process. The selected small molecule additives for use with volatile systems are miscible with water and have a boiling point higher than that of the co-existing water. A small molecule additive useful in a volatile system is further characterized by its greatly lower hydrogen-bonding tendency compared to water. As the additive-loaded volatile system containing the NCEs and the selected small molecule additive undergoes drying, water molecules evaporate preferentially, leaving the small molecule additive behind due to its higher boiling point and thereby increasing the concentration of the additive in the remaining solution that remains in between adjacent NC elements. In embodiments, the molecular segments of the volatile small molecule additives comprise both polar and non-polar functionalities. Not being bound by theory, it is envisioned that the polar segments are attracted by the cellulosic hydroxy groups while the non-polar segments simultaneously interfere with hydroxy-hydroxy interactions, thus reducing adherence between and among the NC elements. Then, as the temperature in the system rises, the additive evaporates, leaving behind the NC elements surrounded by air and thus separated from each other. The resulting dried material, containing NC elements that are separated from each other by air, can be readily re-dispersed without forming indicia of aggregation or consolidation such as observable clumps/clots or concentration variations. The redispersed suspension comprises resuspended NC particles that are uniform in distribution within the suspension, wherein the NC elements retain their nano-size characteristics and can achieve redispersion with only very mild agitation/stirring.

In embodiments, the lists below offer examples of small molecule additives that can be used as drying/dispersal additives in the aforesaid volatile systems to prevent dense aggregation and consolidation, and thereby to facilitate subsequent redispersion of NC elements. Exemplary additives can be divided into two categories: non-ionic and cationic compounds.

Non-Ionic Candidates can Include, without Limitation:
Tri(propylene glycol) butyl ether (TPnB)
Di(propylene glycol) propyl ether (DPnP)
Propylene glycol butyl ether (PnB)
Propylene glycol propyl ether (PnP)
Ethylene glycol monobutyl ether
Propylene glycol monomethyl ether acetate
Propylene glycol diacetate
Ethylene glycol diacetate
Benzyl alcohol
1-Heptanol
1-Hexanol
   Cationic Candidates can Include, without Limitation:
Ethylene diamine
Diethylene triamine
Tetraethylene pentaamine
1,3-Pentane diamine
Piperazine
1,2-Cyclohexane diamine
Aniline
Pyridine
Piperazine

In embodiments, the small molecule additives can evaporate completely from the initial NC suspension, just leaving behind the NC elements in suspension or in dried form without additive residue. However, in other embodiments, trace amounts of the small molecule additives can remain. For example, with certain cationic additives, their cationic groups can adhere to cellulose molecules, so that trace amounts of the additive remain adherent to the cellulose after complete drying. For most industrial applications, the trace residues of these additives do not pose a health or environmental problem. However, in embodiments, a biodegradable cationic small molecule such as 1,3-pentane diamine can be selected to avoid such issues.

iii. Blocking Agents

In embodiments, non-volatile small or large molecule additives can be employed themselves, apart from volatile systems as described above, to hinder hydrogen bonding and/or to create space between the NC elements during drying, thereby blocking interactions between the NC elements and thus preventing the NC elements from aggregating during the drying process. In embodiments, surface-functionalized nanoscale particles can be employed in the same manner. Such non-volatile small or large molecule additives and nanoscale particles employed to carry out this blocking function are referred to herein as blocking agents or blockers. As used herein, the term “blocking agent” or “blocker” includes any non-volatile chemical additive or nanoscale particulate material that itself hinders hydrogen bonding or creates spaces among NC elements, whether the substance is interposed between or among NC elements, or whether the substance offers temporary competitive binding sites for the NC elements, or otherwise.

As an example, caffeine and other xanthine derivatives are small-molecule blockers that can be used advantageously to facilitate isolation of NC elements from each other during a drying or concentrating process and their subsequent redispersion. Not being bound by theory, it is envisioned that the aromatic nitrogen atoms in certain purines (such as caffeine and other xanthines or xanthine derivatives) and pyrimidines can become hydrogen-bonded with the hydroxy groups of the cellulose, presenting a flat, relatively non-polar, and molecularly-lubricating and water-screening outer surface to the NCEs, thus hindering adhesion between and among NC elements. Caffeine and other xanthines and xanthine derivatives can typically be used in quantities that do not present health or environmental problems even when used in sufficient dosages to facilitate NC dispersion.

As another example, certain humectant substances can be employed as blocker molecules. Humectants possess multiple hydrophilic sites such as hydroxyls, esters, and ammonium groups that can form hydrogen bonds with the surface of the NC elements, thus screening the interaction of these elements with each other via hydrogen bonding, and thereby impairing dense aggregation and consolidation. Moreover, these hygroscopic substances are biocompatible and are already widely used in the pharmaceutical, cosmetic, and food industries. Exemplary short and long humectant candidates include but are not limited to glycerin, caprylyl glycol, ethylhexylglycerin, tribehenin, hydrolyzed soy protein, various amino acids, propylene glycol, methyl gluceth-20, phenyl trimethicone, hyaluronic acid, sorbitol, and gelatin.

As yet another example, fatty acids can be employed as blockers as well. Fatty acids contain hydrophilic sites and a hydrophobic tail. The hydrophilic site can form hydrogen bonds with the surface of NC elements, thus screening the interaction of these elements with each other via hydrogen bonding, thereby impairing aggregation. Preferably, fatty acids can be selected that do not contain so many hydrophilic sites that excessive hydrogen bonding will occur between NCE particles and the fatty acids. However, in embodiments wherein too many hydrogen sites may cause dense aggregation and consolidation, the hydrophobic tail of the fatty acid blockers can act to physically prevent dense aggregation and consolidation of NC elements by preventing or interfering with hydrogen bonding. In embodiments, the blocking agent can be a fatty acid, such as stearic acid, palmitic acid, myristic acid, lauric acid, capric acid, caprylic acid, caproic acid, and the like. To facilitate dispersion of the fatty acid in aqueous solutions of NC elements, a water-soluble fatty acid can be selected.

### 2. Redispersible and Redispersed Suspensions of NC Elements

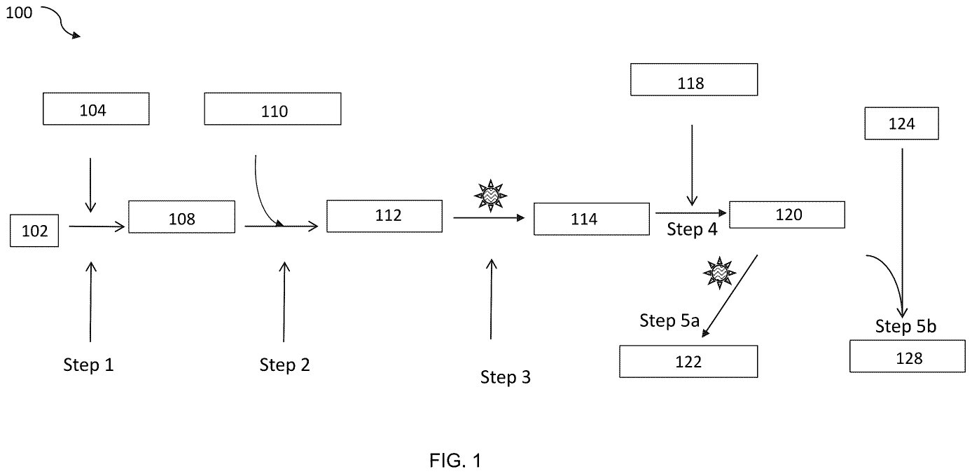

The block diagram of FIG. 1 depicts schematically the processes 100 involved in preparing redispersible suspensions of NC elements that can be further processed to yield redispersed suspensions of NC elements and materials made therefrom. As shown in FIG. 1, the processes 100 for producing a suspension of redispersed NC elements involve four steps.

Step 1 suspends a population of NCEs 102 in a suspension fluid 104 to produce the initial NCE suspension 108. Processes for forming initial NCE suspensions suitable for further processing using the formulations and methods disclosed herein are familiar in the art. To form such a NCE-containing suspension, cellulose sources can be processed using conventional mechanical techniques and optional chemical treatments to extract the component cellulosic nanomaterials (i.e., the NCEs) and retain them as suspended in a liquid or other fluid medium. The NC elements thus extracted form the initial NC suspension, which can be treated to render them redispersible in the next step, using the disclosed formulations and methods.

In Step 2, a drying/dispersal additive 110 as described above is added to the initial NCE suspension 108, to produce a suspension of redispersible NCEs 112. As discussed previously, the drying/dispersal additive 110 allows the NCEs in the initial NCE suspension 108 to be redispersible. The redispersible suspension of NCEs 112 is dried in Step 3, to produce a dried material 114 containing redispersible NCEs. The dried material 114 containing the redispersible NCEs is then either ground/shredded and used as a dry ingredient, or suspended in a resuspending fluid 118 in Step 4, to produce a suspension 120 of the desired concentration of the redispersible NCEs produced as described above; such redispersible NCEs treated by suspension in a resuspending fluid as set forth in Step 4 can also be termed “redispersed NCEs.” In embodiments, the suspension 120 of redispersed NCEs can then be processed by itself, for example by drying or concentrating as shown in Step 5a, to form a simple NCE-based matrix 122 of dried, redispersed NCEs that is formed as a continuous sheet. At a microscopic level, the structure is a three-dimensional, highly porous, and typically forms a largely structurally amorphous network; however, semi-crystalline NCE matrices can be synthesized, if nanocrystalline elements are used and/or crosslinking strategies such as, for example, the grafting and esterification of carboxylic acids onto the surface of NCEs are employed. As used herein, the term “amorphous” refers to any solid formation in which the components are not organized in a definite and repeating lattice pattern. Amorphous structures usually enhance degradability. In addition, additive substances (not shown) can be easily incorporated in the amorphous simple NCE-based matrix 122 to produce advantageous features such as malleability, workability, heat tolerance, strength, or oleophobic or hydrophobic properties.

Pulp-based or pulp-containing additives that do not contain NCEs can also be added, in order to reduce the amount of NCEs that are required to produce desirable properties for the matrix. As used herein, the term “pulp-based” refers to those materials that have been derived from pulp by processing, forming, or treating while retaining pulp or pulp derivatives within their substance.

Pulp is understood to be manufactured from materials containing cellulose or lignocellulosic fibers such as wood, non-wood raw materials, specialty-purpose crops, waste paper, recycled paper, agricultural residues, and the like. Non-wood raw materials such as bagasse, cereal straw, bamboo, reeds, esparto grass, jute, flax, and sisal are familiar in the art as sources of cellulose fibers; certain non-limiting examples of materials containing lignocellulosic fibers are also provided herein. Wood and other plant materials used to make pulp contain three main non-water components: cellulose, lignin, and hemicellulose. The chemical and/or mechanical processes for making pulp aim to break down the bulk structure of the plant material source into constituent fibers, thereby producing the fibrous, cellulose-containing material known in the art as pulp. Pulp can also be formed from previously processed materials such as waste paper or recycled paper or certain fabrics; such materials may lack some or all of the components found in wood or other pulp materials, but can be subjected to chemical or mechanical processes suitable for forming them into pulp.

Pulp and pulp-based materials can be used with the formulations, compositions, and methods disclosed herein, to be formed or shaped as components of or substrates for articles of manufacture in any useful shape, such as sheets, fibers, solid articles, molded articles, etc. Such additives can act as low-cost bulking agents to add volume to the matrix so that a larger amount of simple NCE-based matrix is produced; in such a matrix, the redispersible or redispersed NCEs are added in combination with the bulking agent (for example, conventional pulp or other pulp-based substance) so that the final matrix has the desired mechanical properties.

While NCEs are understood to be additive substances responsible for features of the organization and architecture of the matrix with resulting performance attributes, other additives can be added to the matrix to produce either advantageous features as described above or other desirable properties. For example, appearance-modifying additives such as pigments or other color-producing agents can be added to the matrix, or other additives intended to provide desirable properties, for example, odor-related agents, emollients, cosmetics, pharmaceutical products, medical products, and agricultural active ingredients, fragrances and scents, and the like. Other, related additives can be included in the matrix to allow a particular additive to accomplish its intended purpose. For example, a NCE matrix can include odor-blocking chemicals or natural scents adapted for release in close quarters that have high levels of odoriferant materials, for example in articles such as gym bags, suitcases, etc., or adapted for use in personal articles likely to be odorific (e.g., shoe inserts or liners). A NCE matrix adapted for these purposes can incorporate plasticizers or other additives to tune the release of the anti-odor agents or to adapt their release to certain environmental conditions (for example, shoe liners that emit odor-control substances when in contact with body-temperature feet). Analogously, an NCE-based matrix can be formulated with a deodorant or antiperspirant substances in the matrix interstices, with the NCE-based matrix serving to permit a more durable application of such products to the skin. As further examples, a variety of scents can be employed with the systems disclosed herein. The term “scent” as used herein refers to the variety of odors that can be deliberately incorporated in and delivered by the matrices as described herein. For example, pleasant scents can be employed for cosmetic or aesthetic purposes, or to camouflage unpleasant odors. Scents can be employed for medical, veterinary, or agricultural purposes, to act as insect repellants, pesticides, pheromones, growth hormones, or the like. Scents can be sourced from volatile aromatic compounds, such as essential oils, hydrosols, perfume microcapsules, etc. Exemplary sources can incorporate biological oils and chemical sources suspended in solution for easy application or mixing. Other sources for scents can be aqueous-based, such as hydrosols. Other examples of scent-based technologies based on the formulations disclosed herein include without limitation insecticides for the agricultural sector, perfumes and odor neutralizers for household use, and pet hormones to encourage calm behavior around the home. By controlling the rate of release through careful manipulation of the base technology, the applications can be personalized for various consumer needs, for example, for agricultural products that release pesticides quickly during planting season and more slowly when the plants are fully grown. The technologies disclosed herein can be readily adapted for agricultural purposes, for example with the use of pheromones as the agricultural active ingredients. Pheromones are understood to be secreted or excreted chemicals that trigger a social response in members of the same species. While they may not possess “odors” as the term is commonly understood, pheromone receptors are typically located in the olfactory epithelium or vomeronasal organ, indicating that they are processed by similar pathways as conventional. Pheromones are thus considered odor-related active agents for the purposes of the present disclosure; they are known to be useful in the agricultural industry as pesticides or artificial growth hormones. The foregoing examples are intended to be illustrative and not limiting. Other examples of additive substances that are useful with the matrices disclosed herein can be readily envisioned by those of skill in the art.

Additive substances can become incorporated in or added to the simple NCE-based matrix 122 before, during, or after the processing of Step 5a: the additive substance(s) can be added to the suspension 120 of redispersed NCEs prior to the processing Step 5a, and/or they can be added as the suspension 120 is dried or concentrated, and/or they can be added to the simple NCE-based matrix 122. A material comprising the simple NCE-based matrix 122, wherein the simple NCE matrix 122 provides the architectural framework for the material, and further comprising any additive substances can be termed a “simple NCE-based material.” When the term “matrix” is employed herein, as in “simple NCE-based matrix,” it is understood that the process of matrix-formation described above need not produce a single, continuous simple NCE-based matrix, but can instead produce a plurality of simple NCE-based matrices that are more loosely connected to each other or are discontinuous. If a plurality of simple NCE-based matrices is produced by the processes as disclosed herein, the interrelationship of the matrices thus formed provides organization and architecture that can be carried over into the final simple NCE-based material. In more detail, the NCEs, when redispersed, can form entanglements or attachments with each other that constitute one or more matrices. Physically mixing the liquid formulation comprising the redispersed NCEs can fragment the one or more matrices into smaller ones that associate more loosely with each other. This association of smaller matrices can provide the structural stability that is desirable for the simple NCE-based material. This arrangement is compatible with the addition of pulp or pulp-based substances that can act as bulking agents, fillers, and the like. The architecture of the simple NCE-based matrix allows the pulp or pulp-based material to be integrated into the overall matrix without substantially impairing its strength, stability, and/or durability.

In other embodiments, the suspension 120 can be added to another, existing matrix 124, as shown in Step 5b, to form a composite NCE-containing matrix 128. The redispersed NCEs in the suspension 120 can be termed “additive NCEs” when they are used in Step 5b to be added to the existing matrix 124. In embodiments, the existing matrix 124 provides the architectural framework for the composite NCE-containing matrix, while the NCEs are integrated into the composite NCE-containing matrix 128. An existing matrix 124 can provide an amorphous host matrix, or it can produce a more discernibly ordered pattern of atoms or molecules in a regular lattice-like array, as might be seen in a crystal. In the composite NCE-containing matrix 128, the NCEs become intercalated into the existing matrix 124 to form the composite NCE-containing matrix 128. The more of the additive NCEs that the composite NCE-containing matrix 128 contains, the more the properties of the composite NCE-containing material 128 exhibits properties attributable to the NCEs. For example, a formulation comprising additive NCEs and a pulp-based bulking agent can provide significant strength to a composite NCE-containing matrix 128, while the presence of the pulp-based bulking agent adds volume to the composite NCE-containing matrix 128, potentially making it cheaper to produce. Other properties of the composite NCE-containing matrix 128 can be provided by the existing matrix 124 alone or in interaction with any structural organization or other properties provided by the additive NCEs.

In embodiments, other additive substances can be included in the composite NCE-containing matrix to add or improve desirable features such as malleability, workability, heat tolerance, strength, or oleophobic or hydrophobic properties. Such additive substances can become available for or added to the composite NCE-containing matrix 128 before, during, or after the population of redispersed NCEs from the suspension 120 is added to the existing matrix 124. In embodiments, the existing matrix 124 already includes some or all of the desired additive substances, and their presence carries over into the composite NCE-containing matrix 128. In other embodiments, additive substances are included when the redispersed NCEs and the existing matrix 124 are combined in Step 5b to form the composite NCE-containing matrix 128. In yet other embodiments, additive substances can be introduced into the composite NCE-containing matrix 128 after it is formed. The composite NCE-containing matrix 128 with its included additive substances provides a material that can be further processed, shaped, or otherwise formed into articles of manufacture. A material comprising the composite NCE-containing matrix 128, wherein the composite NCE-containing matrix provides the architectural framework for the material, and further comprising any additive substances can be termed a “composite NCE-containing material.”

Both the simple NCE-based matrix 122 and the composite NCE-containing matrix 128 can be used to provide an architectural framework for materials comprising redispersed NCEs as shown in this Figure, wherein such materials can be formed or shaped to produce articles of manufacture. In other embodiments not depicted in this Figure, a simple NCE-based matrix or a composite NCE-containing matrix can be used to provide an architectural framework for materials comprising redispersible NCEs.

### 3. Redispersible and Redispersed Nanocellulose Elements in Substrates for Producing Articles of Manufacture

As described above, redispersible or redispersed NC elements produced in accordance with the systems and methods disclosed herein can be included in matrices that are used to form NCE-containing materials, both as components of simple NCE-based materials formed solely or predominately from redispersible or redispersed NCEs without including another existing matrix, and as components of composite NCE-containing materials which comprise a composite NCE-containing matrix having redispersible or redispersed NCEs intercalated into an existing matrix. Both simple NCE-based materials and composite NCE-containing materials can be employed as substrates or as components of substrates, including plastic substrates and components of plastic substrates, that can be formed into other articles of manufacture. As used herein, the term “plastic” refers to a material incorporating a three-dimensional framework (or “matrix”) and retaining pliability, thus yielding a NCE-based or NCE-containing material in a pliable state. Such a plastic material can be formed or shaped from its pliable state into a desired configuration and can further be fixed in the desired configuration so that the configuration is retained for a designated period. The process of shaping or forming the material from the pliable state into the desired configuration can be accomplished by many techniques familiar in the art, such as extrusion, calendaring, injection molding, thermoforming, blow molding, and the like. The process of fixing the material in the desired configuration can likewise be accomplished by many techniques familiar in the art, such as heating, applying prolonged pressure, and/or incorporating additives that permit hardening, fixation, or curing. The designated period for retaining the material in the desired configuration will be determined based on its intended use in the article of manufacture and the intended use of the article of manufacture itself (e.g., temporary vs relatively permanent use), and on the intended processes for the disposal of the material and the article of manufacture disposal at the end of its lifespan.

a. Simple NCE-Based Materials

Simple NCE-based materials can be used as plastic substrates for forming into articles having a variety of shapes, with the mechanical properties of such formed articles being due at least in part to structural framework provided by the matrix of dried, redispersible or redispersed NCEs that is integral to the simple NCE-based material. Simple NCE-based materials can thus be used to form articles that have advantageous mechanical properties such as strength and stability but that are also engineered to be dissolvable or degradable at an appropriate time for consumer use. Such articles are envisioned to be relatively temporary in duration, and can be disposed of by biodegrading or composting.

For example, this combination of mechanical properties and dissolvability/degradability allows containers to be constructed from such materials that have sufficient durability to retain their contents during consumer use, but that are furthermore susceptible to decomposition at the end of their intended lifespans. As used herein, the term “container” is to be construed broadly, referring to any receptacle, vessel, or partial or complete enclosure that can be employed in connection with an item or a product for holding, dispensing, delivering, segregating, suspending, structuring, packaging, storing, or portioning said item or product, or for providing similar functionalities derived from the partial or complete enclosure of said item or product therewithin. Exemplary containers include receptacles, vessels or enclosures of all shapes and geometries, whether rigid or flexible, and whether intended for temporary or durable use. Non-limiting examples include cylindrical vessels such as bottles, jars, cups, straws, barrels, cans, drums, tubs, and the like; rectilinear vessels such as boxes, crates, cartons, cases, and the like; flattened receptacles such as plates, trays, dishes, lids, holders, and the like; and delivery systems such as pill capsules or dissolvable foams that deliver a pharmaceutical, agricultural, or other active agent to an area targeted for application, protection, or treatment. Advantageously, containers can provide protection from shock, impact, and mechanical damage, and from elements of the external environment such as weather, pests, and microbes; furthermore, containers can provide protection from oil, grease and water incursion and from leakage of fluids exuded by the contained product. For these reasons, containers are particularly useful for protecting food products.

This combination of mechanical properties and decomposability also allows containers to be constructed from simple NCE-based materials for deliberately ephemeral purposes, such as a container for a fertilizer or agricultural product that is intended to decompose over a very short period of time in order to release the product into the environment. This combination of properties also allows containers to be constructed for rapid or immediate dissolving upon encountering water, for example for delivering active agents for laundry or other home care purposes. Simple NCE-based materials, whose architecture is based on the three-dimensional arrangement of NCEs alone, are entirely bio-based, since they are formed from NC elements. Thus, they offer important alternatives to the petroleum-derived formulations that are used to produce conventional articles of manufacture used for similar purposes, and they provide a vehicle for engineering a foamed article having a combination of mechanical properties and dissolvability that are consistent with the particular purpose of the article.

A significant limitation to the use of simple NCE-based materials is their vulnerability to oil, grease and water: simple NCE-based materials are substantially made from NCEs in combination with other, often cheaper, filler materials such as pulp and pulp-derived substances which tend to offer little intrinsic resistance to the entry of water or oil/grease into the material and their passage therethrough. This vulnerability is exacerbated by the cost of NCEs themselves: NCEs can be admixed with cheaper bulking agents or fillers to reduce the overall cost of a NCE-based material. Pulp or pulp-based substances are frequently employed for this purpose. However, such a material, termed “pulp-dominant” is especially susceptible to the effects of water and grease. In a pulp-dominant material without any other treatment, exposure to water or oil/grease can lead to a loss of structural strength or an actual loss of integrity of a formed article made from such materials.

As used herein, the term “pulp-dominant” refers to a matrix or material in which pulp or a pulp-based material is present in sufficient quantities that it can have substantial effect for the mechanical properties of the material. A pulp-dominant matrix can require additional NCE or other reinforcement to make it as strong, stable, or durable as a non-pulp-dominant simple NCE-based material, depending on the ultimate use of the material; furthermore, such a material can be treated with barrier formulations to make them resistant to the effects of water, oil, and grease, depending on the ultimate use of the NCE-based material. As an example, a pulp-dominant simple NCE-based material can be used to form sheets for personal care items such as facial tissue or toilet paper without much if any additional reinforcement, while a similar material intended for use as a paper towel can require more reinforcement since its ultimate use requires more strength and resilience. A pulp-dominant material can also benefit from treatments to improve its oil and grease resistance and/or its water resistance, depending on the ultimate intended use for such a material.

Simple NCE-based matrices can therefore be treated with formulations that impart oil and grease resistance (oleophobicity) and/or water resistance (hydrophobicity) to the matrix itself or to those materials comprising such matrices. Water resistance in a material is often measured by the water vapor transmission rate, which measures a material's water vapor permeability in units of gm/m²/day, or in g/100 in²/day; the term “water resistance” (WR) thus includes resistance to liquid water and resistance to water vapor. Oil and grease resistance (OGR) and water resistance (WR, and collectively with OGR, “OGWR”) properties can thus be integrated into the materials themselves or into the articles formed therefrom. These OGWR properties can also be termed “barrier properties,” and a substance or formulation that produces one or more barrier properties can be termed a “barrier-producing formulation” or “barrier formulation.” A “barrier substance” refers to a substance that produces a barrier property. Both oil/grease resistance (or oleophobicity) and water resistance (or hydrophobicity) can be individually termed a barrier property.

Barrier properties can be tuned within a simple NCE-containing material to permit differential permeability of the material to various fluids (whether oil, grease, or water). As an example, in embodiments a barrier-producing formulation may impart both OGR and WVR properties to the article it treats, with the relative strength of each property being tunable by adjusting the ingredients selected for the formulation itself, and/or by adjusting the relative amounts of its ingredients, for example to emphasize hydrophobicity or oleophobicity.

In embodiments, NCEs alone, or NCEs modified with barrier-producing substances such as lignin, wax, fatty acids and the like, are able to impart a certain degree of oleophobicity or hydrophobicity to the simple NCE-based material, and their concentration can be adjusted to optimize this barrier property, Without being bound by theory, it is thought that the tight packing of NCEs can enhance the barrier properties that they provide. In addition, despite their intrinsic hydrophilicity, NCEs (either alone or modified with barrier-producing substances) can, under certain circumstances, be sufficiently tightly packed in simple NCE-based materials that they impart water resistant or vapor resistant barrier properties to those materials.

In embodiments, a wide range of additive ingredients can be combined to provide desired barrier properties. For example, a barrier-producing formulation that is suitable for use with simple NCE-based matrices can include a cellulose ether such as methylcellulose, and/or a resin acid. Alternative cellulosic ingredients for the barrier-producing formulation can include, without limitation, CMC (carboxymethyl cellulose), CMCNa (sodium carboxymethyl cellulose salt), CA (cellulose acetate), CDA (Cellulose diacetate), cellulose triacetate (CTA), CAB (cellulose acetate butyrate), CAPh (cellulose acetate phthalate), CAP (cellulose acetate propionate), EC (ethyl cellulose), HEC (hydroxyethyl cellulose), EHEC (ethyl hydroxyethyl cellulose), HPC (hydroxypropyl cellulose), HPMC (hydroxypropyl methylcellulose), HPMCP (hydroxypropyl methylcellulose phthalate), HPMCAS (hydroxypropyl methylcellulose acetate)). Methylcellulose is particularly advantageous in barrier-producing formulations for simple NCE-based matrices due to its oil and grease resistance, its high viscosity, and its unique lower critical solution temperature (LCST) that causes it to gel when heated. Resin acids and combinations thereof (such as rosin, gum rosin, pitch, and the like) can be used alone or in conjunction with methylcellulose to provide water resistance. Cellulose acetates are also particularly advantageous ingredients in barrier formulations, especially for food and beverage containers, given that they can produce both oleophobic and hydrophobic properties.

In more detail, resin acids are bio-derived gums that are tacky and water-insoluble in their native state, characterized as unsaturated diterpenecarboxylic acids with a phenanthrene ring structure, having the empirical formula C₁₉H₂₉COOH. Resin acids include abietic acid, palustric acid, levopimaric acid, neoabietic acid, dehydrogenated ibuptic acid, pimaric acid, isopimaric acid and sandaracopimaric acid. They can be separated into two categories according to their chemical structural formulas, abietic-type resin acids and pimaric type resin acids. The monomeric molecule of the abietic type resin acid has two conjugated double bonds and one isopropyl. Dehydrogenated abietic acid, abietic acid, palustric acid, and levopimaric acid are examples of abietic type resins. The monomeric molecule of pimaric-type resins has a methyl and vinyl at the C13 position and has two independent double bonds. This type of structure is predominantly found in pine-bearing resins and pine resin, such as pimaric acid, isopimaric acid, and sandaracopimaric acid, and pimaric resin acids.

Resin acids' carboxyl group(s) can react with a polyol (e.g., glycerol, erythritol, etc.) to form esters (thus binding three or four resin acid molecules together to create an “oligomer” of a basic resin acid building block such as abietic acid). Resin acids tend to be glassy and stiff at room temperature. Depending on plasticization, they can be softened by temperature increase, and amount of plasticizer used. Resin acids are compatible and miscible with a variety of oils/waxes to tune thermal or physical properties (such as but not limited to glass transition temperature, ductility, and hydrophobicity). For example, beeswax and carnauba wax are soluble in certain resin acids, thus affecting the melting and glass transition temperatures while also decreasing their solubility in solvents. Other examples of suitable oils and waxes to admix with resin acids include, without limitation:
Mineral oils and waxes (paraffins)
Beeswax
Carnauba wax
Flax seed wax
Candelilla
Lard
Coconut oil
Linseed oil
Eucalyptus essential oil
Cocoa butter
Sweet almond oil
Olive oil
Palm oil
Castor oil
Sunflower oil
Canola oil

The proportion of these ingredients in the barrier-producing formulation can be tuned to optimize its OGR properties and the WVR properties, and thus to engineer the desired amount of OGWR in the simple NCE-based material that are formed by adding the specific barrier-producing formulation to the simple NCE-containing matrix.

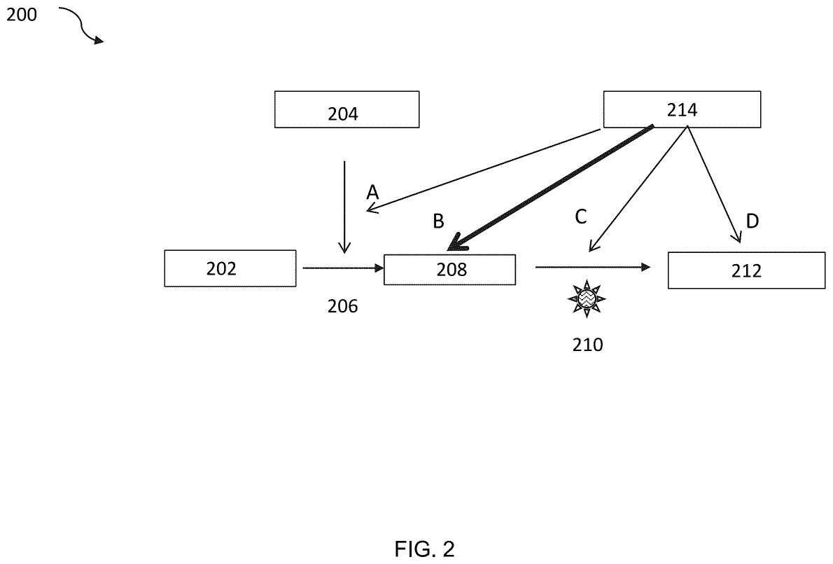

The block diagram of FIG. 2 illustrates schematically how the barrier-producing formulation can be added during the formation of the simple NCE-based matrix and its subsequent processing. The process 200 in FIG. 2 begins with providing a dried material 202 containing redispersible NCEs, where such dried material has been prepared substantially as described in connection with FIG. 1. The dried material 202 containing the redispersible NCEs is then ground/shredded and used as a dry ingredient, or suspended in a resuspending fluid 204 to resuspend the NCEs in the dried material 202 and to form a suspension 208 of the desired concentration of redispersed NCEs, substantially as described in connection with FIG. 1. The suspension 208 of redispersed NCEs is then subjected to drying 210 to produce the simple NCE-based matrix 212 that can then be used to form the simple NCE-based material, substantially as described in connection with FIG. 1. A barrier-producing formulation 214 can be added at points A, B, C, and/or D. In more detail, the barrier-producing formulation 214 can be added as part of the step 206 wherein the dried material 202 containing redispersible NCEs is treated with the resuspending fluid 204 to produce the suspension 208 of redispersed NCEs. For example, the barrier-producing formulation 214 can be added to the redispersing fluid 204, as indicated by its introduction at point A. The barrier-producing formulation 214 can also be added to the suspension 208 of redispersed NCEs, as indicated by its introduction at point B. The barrier-producing formulation 214 can also be added during the step of drying 210, in which the suspension 208 of redispersed NCEs is processed, ultimately to form the simple NCE-based material 212, as indicated by its introduction at point C. Finally, the barrier-producing formulation can be added to the simple NCE-based material 212, as indicated by its introduction point at point D. Although a single barrier-producing formulation 214 is depicted in this Figure, it is understood that a plurality of barrier-producing formulations or barrier-producing formulation ingredients can be added at the different introduction points. A first barrier-producing formulation can be added at one introduction point, and a second barrier-producing formulation can be added at a second introduction point. Combinations of barrier-producing formulations and their ingredients can be introduced at any point during the process, using methods familiar in the art, such as (without limitation) mixing in the formulations, spraying them onto or into the designated substrate, or painting them on its surface. Such barrier-producing formulations can include redispersed NCEs to enhance performance and act as pore closers in their interaction with the surface of the existing NCE-containing material onto which the coating is deposited. Barrier-producing formulations that do not contain redispersed NCEs can be applied to impart enhanced performance as well.

An exemplary simple NCE-based material having OGWR properties can be produced as follows, with the barrier-producing formulation being added to a suspension of redispersible or redispersed NCEs. A suspension of redispersible (in this case, redispersed) NCEs, prepared as discussed above, is provided, into which methylcellulose (MC) is added with or without a sugar alcohol plasticizer (glycerol, xylitol, maltitol, sorbitol, erythritol, mannitol, and the like). Adding these ingredients is intended to produce oleophobicity. The suspension of such redispersible or redispersed NCEs can contain NFCs, MFCs, or both. The suspension of such redispersible or redispersed NCEs can also include bulking agents such as pulp or pulp-based ingredients to provide more volume to the final simple NCE-based matrix and resulting materials. Separately, a solution of rosin is prepared by mixing rosin into an alcohol or ketone solvent (e.g., ethanol or acetone) to achieve a 10-100 wt % (wt rosin/wt solvent) solution of rosin in the solvent. After this solution has been prepared, with the rosin adequately dissolved, it can be emulsified in water using polyethylene glycol (PEG) at 1-25% relative to the weight of rosin, preferably using an in-line homogenizer, or it can be directly mixed into the MC-containing suspension of redispersible or redispersed NCEs. A small amount of the solvent used to prepare the mixture can be added to the suspension of NCEs, before the rosin mixture is added, to encourage homogenization. The mixing process can take place vigorously, for example pouring rosin-based formulation slowly into the NCE-containing resuspension at medium to high shear, or spraying as a fine mist into solution at relatively low shear, to nucleate a fine suspension of rosin in the liquid phase throughout the MC-NCE containing suspension. It is advantageous to add the rosin solution as a highly pressurized stream or to create a water-based emulsion, so that rosin particulate size is small. Following the combination of these ingredients the resulting mixture can be dried, producing the simple NCE-based matrix that can be processed to yield the simple NCE-based materials.

Rosin addition improves the hydrophobicity of the matrix. Rosin efficacy for hydrophobicizing can be increased by heat-treating the rosin before dissolving it in the solvent, for example by heating the rosin at about 200° C. for about 10-30 minutes to remove impurities such as turpentine. Heat treatment will also increase the softening point rosin from 45° C. to 59° C., making it more resilient when subjected to heat during later stages of processing. In an embodiment, rosin can be loaded at an amount of about 35 wt % relative to dry pulp weight, though amounts of rosin relative to dry pulp weight ranging from about 5 wt % to about 50 wt %, about 5 wt % to about 10 wt %, about 8 wt % to about 25 wt %, about 20 wt % to about 40 wt %, or about 35 wt % to about 55 wt % can be employed. In an embodiment the ratio of the redispersible or redispersed NCEs to MC is about 1:3. Other ratios of NCEs to MC ranging from 5:1 to 1:3 can be employed.

A simple NCE-based matrix having OGWR properties can be produced by combining the ingredients as described above. This matrix can then be formed into a simple NCE-based material that can be used to produce articles of manufacture. To improve the retention of other additives in the simple NCE-based material, retention aids can be added to the simple NCE-based matrix. Retention aids, typically cationic polymers or surfactants, are familiar in the papermaking industry; for example, substances such as chitosan or PDADMAC can be used as retention aids.

In exemplary embodiments, OGR and WVR materials as disclosed herein can be used as barrier-producing formulations with simple NCE-based materials, either as coatings to be applied to the surface of the material or as mix-in additives. In more detail, OGR and/or WVR formulations can be used as coatings, or can be mixed into the simple NCE-based material as described above, which then can be shaped (e.g., thermoformed) into a product.

As an example, foamed containers or foamed parts for containers formed from simple NCE-based materials can be prepared having OGR properties and/or WVR properties, enabling the containers to securely confine and deliver liquids, gels, or wetted solids to the consumer for other purposes. Such simple NCE-based materials can be pulp-dominant, with appropriate adjustments of amounts of NCEs and barrier-producing formulations, based on amount of pulp or pulp-based materials they contain. In embodiments, the barrier-producing formulation can also be applied to the surface of the simple NCE-based material prior to its forming or shaping into the formed article, or the barrier-producing formulation can be applied to the formed article after the forming or shaping has taken place. For example, the barrier-producing formulation can be applied superficially to a precursor material or article of manufacture, using conventional application procedures such as painting or blade painting, curtain coating, and the like, or spraying if the formulation is of a viscosity that is compatible with the selected spraying apparatus. In other embodiments, the barrier-producing formulation can be integrated into the simple NCE-based formulation (as described above) at any concentration; then, before molding/thermoforming takes place, the mixture can be heated to just above the lower critical solution temperature of the LCST polymer component of the barrier-producing formulation. This procedure allows the LCST polymer dispersed within the mixture to precipitate (or “crash out”) onto the fibers or the surface of the simple NCE-containing matrix structure.

In embodiments, a bulking agent such as pulp or a pulp-based material can be added to the simple NCE-based matrix to form a pulp-dominant simple NCE-based material, as mentioned above. In such a material, the NCEs can interact with the pulp or pulp-based bulking agent so that it coats them or fills in pores in between the fibers of the pulp or the fibers of the pulp-based material. In this capacity, the simple matrix or matrices formed within the simple NCE-based material can act as pore-closers to fill gaps in the pulp material. This pore-closing allows this sort of simple NCE-based material to be used with pulp or pulp-based substances to form high-value specialty paper products having properties that reflect the behavior of the NCE matrices. As an example, a paper product with NCE matrices embedded in its pores can offer or improve oil and grease resistance (especially in conjunction with other barrier materials), since the embedded NCE matrices close the pores within the paper substance that would otherwise allow the passage of grease through the product. As another example, a paper product with embedded NCEs in its pores can be engineered to form a releasable label backing or selective adhesive. In embodiments, barrier-producing formulations as described above can be added to the simple NCE-based material to enhance the effects of the NCE matrices as pore-closers, for example by imparting oleophobic or hydrophobic properties to the material which can then be carried over into pulp-dominant paper type products made therefrom.

In embodiments, filler particles can be added to simple NCE-based matrices and materials for bulking effect, and/or to act as pore closers. These filler particles can be used in addition to barrier-producing formulations, or instead of them; in either case, the filler particles can interact with the pulp fibers and the simple NCE matrices to impart barrier properties such as oleophobicity and/or hydrophobicity; as well, filler particles can affect mechanical properties such as strength, toughness, flexibility, and elasticity.

Such filler particles can include, without limitation, large or small particles of any shape, or mixtures of different sizes and shapes, made from natural or artificial materials, made with any method of processing (for example, without limitation, physical grinding, precipitation, emulsification), including organic or inorganic components; by way of illustration, particles useful for this purpose can comprise, without limitation, sand particulates, ceramic particulates, biomass materials or particulates, mineral particulates, resinous materials, glass materials, polymeric materials, rubber materials, composite particulate materials, chemically active materials such as fatty acids, surfactants, and sugar alcohols, organic materials such as wood or nutshells that have been chipped, ground, pulverized or crushed to a suitable size (e.g., walnut, pecan, coconut, almond, ivory nut, Brazil nut, and the like), seed shells or fruit pits that have been chipped, ground, pulverized or crushed to a suitable size (e.g., plum, olive, peach, cherry, apricot, etc.), coffee grounds, pinecone dust, sisal, rice hull ash, rice hull, coconut shell, cotton stalk and the like, chipped, ground, pulverized or crushed materials from other plants such as corn cobs, specific inorganic particles such as solid glass, glass microspheres, fly ash, silica, alumina, fumed carbon, carbon black, graphite, mica, boron, zirconia, talc, kaolin, titanium dioxide, calcium carbonate (e.g., precipitated calcium carbonate (PCC) or ground calcium carbonate (GCC)), wood flour, lignin, mica, dolomite, wollastonite, halloysite, calcium silicate, flame retardants (such as, but not limited to halogenated (chlorinated or brominated), phosphorous-based, nitrogen-based, inorganic/mineral based flame retardants, for example, hexabromocyclododecane (HBCD), triphenyl phosphate (TPP), tricresyl phosphate (TCP), phenol isopropylated, phosphate 3:1 (PIP 3:1) and the like, as well as combinations or composites of these or similar different materials. In embodiments, plant-derived organic materials such as (without limitation) wood or nutshells that have been chipped, ground, pulverized or crushed to a suitable size (e.g., walnut, pecan, coconut, almond, ivory nut, Brazil nut, and the like); seed shells or fruit pits that have been chipped, ground, pulverized or crushed to a suitable size (e.g., plum, olive, peach, cherry, apricot, etc.); coffee grounds, pinecone dust, sisal, rice hull ash, rice hull, coconut shell, cotton stalk, and the like; and chipped, ground, pulverized or crushed materials from other plants such as corn cobs, are especially advantageous for use as filler particles.

Advantageously, in certain embodiments filler particles can be selected that can be hydrophobic in nature, or that can be made hydrophobic (e.g., functionalized PCC), for example by linking or coating them with a hydrophobic material such as stearic or oleic acid. In embodiments, the filler particles can comprise waxes, either as the substance for the particle itself or as a coating for other particles, and these waxes can be in wax form or emulsion form (oil-in-water wax emulsion). For example, a waxy substance such as beeswax, soybean wax, carnauba wax, and the like, can be used, either as a base particle or as a coating for other filler particles. As used herein, the term “wax” refers to any hydrocarbon that is lipophilic and a malleable solid near ambient temperatures, typically having a melting point above about 40° C. As examples, waxes can include long-chain aliphatic hydrocarbons typically having 20-40 carbon atoms per molecule, or fatty acid/alcohol esters typically containing from 12-32 carbon atoms per molecule, such as myricyl cerotate, found in beeswax and carnauba wax. Filler particles can be mixed into the barrier-producing formulation to impart pore-clogging functionalities.

b. Composite NCE-Containing Materials

Composite NCE-containing materials, formed from composite matrices in which the redispersible or redispersed NCEs are integrated into existing matrices, can be used as plastic substrates for forming a multitude of products. After they are mixed into the existing matrix, the additive NCEs can be deployed as particles or as more elongated fibrous structures and can align with themselves in a straight or randomly oriented way, to form networks or other internal architecture in combination with the existing matrix that is embedded within the composite NCE-containing material. In embodiments, the three-dimensional matrix framework of the existing matrix substance is coated with and/or impregnated with additive NCEs to form the composite NCE-containing matrix, wherein the presence of the additive NCEs imparts a specialized property that exceeds those found in the existing matrix, or that is not found in the existing matrix. For example, the composite NCE-containing material can exhibit a specialized mechanical property such as strength, hardness, toughness, brittleness, stiffness, cohesion, durability, impact resistance, optical transparency, and the like, where the presence of the NCEs in the composite NCE-containing material produces or improves upon that specialized mechanical property.

As another example, the composite NCE-containing material can exhibit a specialized barrier property such as an OGWR property that can be present in the existing matrix but is improved in the composite NCE-containing material, or that is absent in the existing matrix but is provided in the composite NCE-containing material. In embodiments, NCEs alone, or NCEs modified with barrier-producing substances such as lignin, wax, fatty acids and the like, are able to impart a certain degree of oleophobicity or hydrophobicity to the composite NCE-containing material, and their concentration can be adjusted to optimize this barrier property. Without being bound by theory, it is thought that the tight packing of NCEs can enhance the barrier properties that they provide. In addition, despite their intrinsic hydrophilicity, NCEs (either alone or modified with barrier-producing substances) can, under certain circumstances, be sufficiently tightly packed in composite NCE-containing materials that they impart water resistant or vapor resistant barrier properties to those materials.

Combining redispersible or redispersed NCEs with an existing matrix can allow the presence of the NCEs to act as pore closers in their interaction with the existing matrix. Under these circumstances, the redispersible or redispersed NCEs can interact with the existing matrix so that it coats it, or fills in the pores or gaps within the network provided by the existing matrix. In embodiments, these pore-closing effects can be boosted when used in combination with other oil-and-grease-repellent additives. In this capacity, the NCEs and any matrices that they form can act as pore-closers to fill the gaps in the existing matrix, thereby acting as plugs to impair the passage of certain molecules, such as oil and grease, through the composite NCE-containing matrix. This mechanism is similar to the behavior or NCEs as pore-closers for simple NCE-based materials. Also, filler particles can be added to composite NCE-containing matrices, similarly to how filler particles can be added to simple NCE-based matrices. The role of filler particles has been described above in detail with reference to simple NCE-based materials; mutatis mutandis, that description can be applied to the use of filler particles for composite NCE-containing materials. Briefly, filler particles can be added to complex NCE-containing matrices for bulking effect, and/or to act as pore closers for simple pulp-based matrices, alone or in conjunction with other barrier materials. In various embodiments, filler particles can be used in addition to barrier-producing formulations, or instead of them; in either case, the filler particles can interact with the existing matrices and/or the composite NCE-containing matrices to impart barrier properties such as oleophobicity and/or hydrophobicity.

More generally, the process of formulating composite NCE-containing materials from composite NCE-containing matrices can be engineered in order to produce the desired material properties. The production of OGWR properties by the incorporation of barrier-producing formulations in such materials is one example of how composite NCE-containing matrices can be engineered to produce such material properties. Existing matrices can be formulated to make them especially suitable for combining with the redispersible or redispersed NCEs in order to form the composite NCE-containing matrices and to produce composite NCE-containing materials. For example, the degree of flexibility in a product formed from the composite NCE-containing materials can be fine-tuned by varying the composition of the existing matrix, the amount of additive NCEs used in the existing matrix to form the composite NCE-containing matrix, and/or the amount of various additives intended to optimize properties of the final composite NCE-containing material. By selection of appropriate additives and polymers for the existing matrix within which NCEs are integrated to form a composite material, such additives can produce properties such as structural strength, resilience, elasticity, water resistance, oil and grease resistance, and the like, for manufactured articles formed therefrom, in combination with biodegradability.

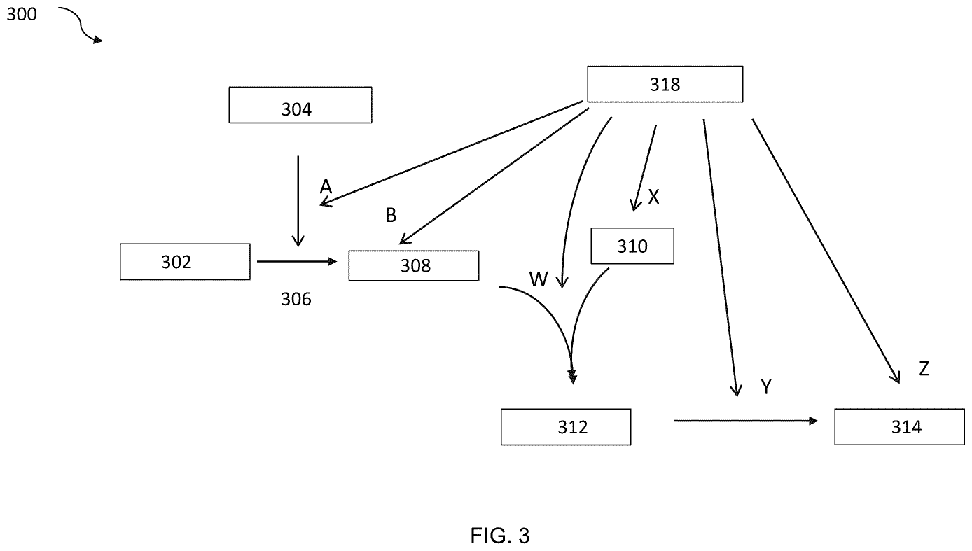

The block diagram of FIG. 3 illustrates schematically how the barrier-producing formulation can be added during the formation of the composite NCE-containing matrix and its subsequent processing. The process 300 in FIG. 3 begins with providing a dried material 302 containing redispersible NCEs, where such dried material 302 has been prepared substantially as described in connection with FIG. 1. The dried material 302 is then treated with a resuspending fluid 304 in a resuspending step 306 to form a suspension 308 of redispersed NCEs, substantially as described in connection with FIG. 1. The suspension 308 of redispersed NCEs is then combined with an existing matrix 310 to produce the composite NCE-containing matrix 312, substantially as shown in Step 5a in FIG. 1. The composite NCE-containing matrix 312 can be combined with additives and/or further processed to form a composite NCE-containing material 314. The barrier-producing formulation 318 can be added at points A and B substantially as described in connection with FIG. 1. Alternatively, or in addition, the barrier-producing formulation 318 can be added at one or more of points W, X, Y, and Z. In more detail; the barrier-producing formulation 318 can be added as the suspension 308 of redispersed NCEs is mixed with the existing matrix 310, as indicated by point W; the barrier-producing formulation 318 can be added to the existing matrix 310 before it is mixed with the suspension 308 of redispersed NCEs, as indicated by point X; the barrier-producing formulation 310 can be added to the composite NCE-containing matrix 312 as it is processed to become the composite NCE-containing material 314, as indicated by point Y; and/or the barrier-producing formulation 310 can be added to the composite NCE-containing material 314, as indicated by point Z. For this last type of application, advantageously the barrier-producing formulation can be sprayable to permit easy application, whether to the surface of the composite NCE-containing material 314 or to the surface of formed articles manufactured therefrom (not shown). Although a single barrier-producing formulation 318 is depicted in this Figure, it is understood that a plurality of barrier-producing formulations or barrier-producing formulation ingredients can be added at the different introduction points W, X, Y, or Z. A first barrier-producing formulation can be added at one introduction point, and a second barrier-producing formulation can be added at a second introduction point. Combinations of formulations and/or barrier-producing formulations ingredients can be introduced at any point during the process.

In embodiments, barrier-producing formulations can be prepared that contain biopolymers as additives to impart OGWR properties or other useful properties to composite NCE-containing materials, similar to how such additives can be used with barrier-producing formulations that are combined with simple NCE-based materials. Such additives can be added to the barrier-producing formulation, which then can be combined with the composite NCE-containing matrix as described above. Biopolymers can include biopolyesters such as polyhydroxy-alkanoates and polylactic acid derivatives. Advantageously, certain exopolysaccharides such as pullulan, kefiran, cellulose, levan, gellan, and the like can be used to form films, which can be advantageous for those barrier-producing formulations that are used as coatings for composite NCE-containing materials and useful articles made therefrom. Such biopolymers can also include, without limitation, exopolysaccharides such as bacterial cellulose, kefiran, pullulan, levan, gellan, other naturally occurring polysaccharides such as alginate, lignin, carrageenan, gum Arabic, starch and plant glucomannans-like locust bean gum, mannan, guar gum, and the like, and cellulose derivatives. As used herein, those products created by the modification of the native cellulose polysaccharides are termed “cellulose derivatives,” “cellulosic polymers,” or “cellulosics.” Such modifications can include chemical modifications, such as cellulose degradation and derivatization of —OH groups. Acid/base, oxidative, biological, and mechanical processing are all examples of degradation reactions. Modifications that introduce new functional groups in the cellulose backbone include reactions such as carboxymethylation, oxidation, and addition reactions. Other reactions such as esterification, acylation, grafting, and etherification can also produce cellulose derivatives. Other examples of reactions producing cellulose derivatives are well-known in the field.

A variety of specialized properties of composite materials using NCEs have already been contemplated in industry, but their use has been hampered by the redispersion problems mentioned previously. The redispersion technologies disclosed herein facilitate the transportation of NCE compositions that can be concentrated or dried and then be resuspended to be combined with existing matrices, yielding composite NCE-containing materials. In embodiments, these redispersion technologies can produce a uniform mixture of high-aspect-ratio NCEs within the primary matrix-forming material, allowing enhancement of desirable specialized properties in the final composite, including mechanical properties such as are mentioned above. In other embodiments, NCE formulations produced using the redispersion technologies disclosed herein can be prepared so that they introduce or enhance specialized properties such as barrier properties that allow the composite NCE-containing material to have desirable degrees of oil and grease resistance and/or water vapor resistance.

Redispersible and redispersed NCEs produced as described herein can act as fillers in composite NCE-containing matrices. Fillers are understood to improve mechanical and barrier properties of organic and substances such as plastics, and/or to make them or products made from them more economical to produce or ship, for example by requiring less amounts of expensive ingredients, or by making them more lightweight. Redispersible and redispersed NCEs produced as described herein can also be combined with other bulking agents such as pulp or pulp-based substances to increase the final volume of the composite NCE-containing matrix while retaining strength through the presence of the additive NCEs. While NCEs have already been used as fillers in plastics, their use has been limited by their resistance to redispersibility.

The methods for NCE redispersion disclosed herein can permit the more widespread use of NCEs for purposes such as reinforcement of composite materials and plastic substrates, and can further permit a dramatic expansion of new uses. As used herein, the term “reinforcement” refers to an improvement of a mechanical characteristic that is found in the existing matrix pertaining to strength, hardness, toughness, brittleness, stiffness, cohesion, flexibility, durability, or impact resistance, or a provision of such a mechanical characteristic if it is not already present in the existing matrix. A composite NCE-containing matrix having improved mechanical properties as compared to the existing matrix can be termed “reinforced,” with the reinforcement of the composite NCE-containing matrix being attributable to the presence of the NCEs. NCEs can be used as fillers in a variety of environments, as the foregoing examples demonstrate.

In certain embodiments, the composite NCE-containing matrix is formed from a petroleum-derived existing matrix into which the redispersible or redispersed NCEs are incorporated. In other embodiments, the composite NCE-containing matrix is formed from a bio-based existing matrix into which the redispersible or redispersed NCEs are incorporated.

i. Petroleum-Derived Existing Matrices

In embodiments, petroleum-derived polymers are used to form the existing matrices that are combined with additive (redispersible or redispersed) NCEs to form composite NCE-containing matrices with advantageous properties. A variety of petroleum-derived polymers can be used as existing matrices to form composite matrices with NCEs, for example polyvinyl alcohol, high-density polyethylene, low-density polyethylene, polyvinyl chloride, acrylonitrile butadiene styrene, polypropylene, polylactic acid, polybutylene succinate, polyethylene succinate, polypropylene succinate, and the like. The addition of NCEs to these matrices can provide specialized properties such as a mechanical property, for example increased strength and/or flexibility, or a barrier property such as an oleophobic or a hydrophobic property or a water-vapor resistant property. Furthermore, redispersible or redispersed NCEs can be added to the matrices as ingredients in a formulation that also includes a bulking agent such as pulp or a pulp-based substance. Such formulations can provide added volume to the resultant composite NCE-containing matrix while the NCE component retains or improves its mechanical properties as compared to the existing matrix. The use of such formulations, comprising redispersible or redispersed NCEs and bulking agents, can reduce the need for other expensive ingredients and thus can lower the overall cost of the resultant composite NCE-containing matrix and materials produced therefrom.

However, the use of redispersible or redispersed NCEs as additive NCEs in combination with hydrophobic existing matrices presents challenges because the NCEs themselves are hydrophilic. While incorporation of additive NCEs into hydrophobic existing matrices can pose problems due to the weak interfacial strength between the hydrophobic polymer matrix and hydrophilic NC elements, the redispersible or redispersed NCEs can be further modified to become more hydrophobic so that a stronger interface is created. For use in a hydrophobic environment, the NCEs can be surface-modified to match the properties of the hydrophobic existing matrix in which they are to be incorporated, so that they are compatible with the existing matrix and can be regularly dispersed within it. In embodiments, surface modification of additive NCEs prepared in accordance with the methods disclosed herein can be performed, for example using a hydrophobic monolayer on the NCEs. Methods for this modification can include silane coupling, alkali treatment, acetylation, carbonylation, TEMPO oxidation, polymer grafting, bacterial modification, surfactant addition, and the like. In embodiments, NCEs that have been hydrophobized for use in hydrophobic matrices can be prepared so that they are not only redispersible upon drying but are also, by virtue of their hydrophobic coating, compatible with various hydrophobic polymeric existing matrices, such as thermoplastic and thermoset matrices (e.g., polypropylene, polyethylene, polystyrene, polyesters, poly(acrylates/methacrylates), rubbers, silicones, urethanes, epoxies, and the like, to yield strong and lightweight composite NCE-containing materials for further processing to provide articles of manufacture. Other modifications can include those that enhance the interfacial adhesion between the hydrophobic matrix and the hydrophilic NCEs such as incorporating another additive (e.g., a fatty acid or a surfactant) that has a polar head and a nonpolar tail; it would be understood that this additive could interact with both the hydrophobic matrix and the hydrophilic NCEs to improve their adhesion to each other.

As previously described, other additives to obtain desirable properties can be added to the composite NCE-containing matrices to produce composite NCE-containing materials useful as plastic substrates. Such additives can be added at any stage in the production of the composite NCE-containing material, for example, being added to the existing matrix, or to the composite NCE-containing matrix, or to the composite NCE-containing material. For example, plasticizers such as phthalate esters can be employed to make the material more pliable and versatile. Such a composite NCE-containing material containing a plasticizer can then be shaped by conventional techniques such as extrusion, calendaring, injection molding, thermoforming, blow molding, and the like, to produce formed articles. The redispersible or redispersed NCEs embedded in the composite NCE-containing matrix act as reinforcers, such as fillers, particles, or fibers that improve the mechanical properties of the material that has been softened by the plasticizers.

ii. Bio-Based Existing Matrices

In embodiments, bio-based polymers are used to form the existing matrices that are combined with additive NCEs to form composite NCE-containing matrices with advantageous properties. Under these circumstances, all the structural components of the composite NCE-containing matrix are bio-based, as is the composite NCE-containing material formed from the composite NCE-containing matrix. This composite NCE-containing material can be used as a plastic substrate to be formed into articles of manufacture. Producing this plastic substrate from bio-based components (i.e., redispersible or redispersed (additive) NCEs and a bio-based existing matrix) offers sustainability benefits, both in eliminating reliance on petrochemical raw materials and in facilitating the degradation and disposal of products formed from such plastic materials.

In those embodiments that use bio-based polymers to form the existing matrix, the constitutive bio-based polymer forming the existing matrix can be a homopolymer, copolymer, polymer blend, or any combination of the foregoing. Additive ingredients can be combined with the constitutive bio-based polymer to optimize properties of the existing matrix. For example, cellulose acetate (CA) and cellulose butyrate (CAB) can be blended together in an acetone solution to form an existing matrix; alternatively, one of the two cellulosic polymers could be used independently. Additional or alternative cellulosic polymers that can be used for the existing matrix include cellulose acetate propionate, methyl cellulose, hydroxypropyl methyl cellulose, hydroxypropyl cellulose, sodium carboxymethyl cellulose, carboxy methyl cellulose, cellulose acetate phthalate, hydroxyethyl cellulose, chitosan, and the like.

Polyhydroxyalkanoates (PHAs), including poly-3-hydroxybutyrate (PHB), polyhydroxyvalerate (PHV), polygydroxyhexanoate (PHH) and the like can also be used to form a matrix. Polybutylene succinate (PBS), polybutylene succinate-co-adipate (PBSA), and the like produced from biomass can also be used to form a matrix. In embodiments, one or more plasticizers can be added to the existing matrix to soften and increase its flexibility. Bio-based plasticizers can be added into the existing matrix can include fatty acids, polyols, epoxidized triglyceride vegetable oils, alkyl esters of adipic and citric acids, and the like; examples of such plasticizers include, without limitation, triglycerin, tributyl citrate, triethyl citrate, acetyl triethyl citrate, polyethylene glycol, epoxidized soybean oil, oleic acid, and the like. Bio-based resinous materials, such as gum rosin, can be added to hydrophobize, stiffen, and/or bind the existing matrix and limit the degree of flexibility; such materials have other advantages, for example acting as a glue-like substance to affix matrix pieces to each other or to form bridges between them. Such materials can have the additional advantage of aiding in hydrophobization of the matrix and any subsequent materials derived therefrom if water resistance is desired for end use. Further additives can be included to optimize material properties for end use applications. For example, fillers and bulking agents can be added: pulp can be included as a filler or bulking agent in the existing matrix to reduce cost and improve texture; wood flour, saw dust, ash, mineral powders, lignin, and other low cost filler particulates can be used to reduce cost and/or close pores within a matrix; precipitated calcium carbonate and stearic acid can be added in the existing matrix to improve hardness and hydrophobicity, and precipitated calcium carbonate alone can be added to act as a nucleation agent or to provide brightness. Alternatively, or in combination with other additives, an oil-grease resistant and/or water-resistant (OGWR) formulation can be incorporated into the existing matrix to obtain hydrophobicity and oleophobicity as desired. Biodegradability-boosting additives can be used to aid in quick decomposition of the matrices after disposal; for example, silica particles can be integrated into a CAB-plasticized matrix.

As examples, photocatalysts, pro-oxidants, and enzymes may be used to accelerate the degradation of NCE-containing materials once they enter the landfill. Using the example of enzymes, and without being bound by theories, it is understood that the following mechanisms explain the activities of certain of these biodegradability-boosting additives. To degrade the different cellulose derivatives first the functional groups need to be broken off and then the β-1,4-linkages in the cellulose backbone are able to further break apart. Unmodified cellulose can be degraded by cellulase and β-glucosidase enzymes. Lipase or acetylesterase are examples of enzymes that can be used to hydrolyze the acetyl group in cellulose acetate. By incorporating enzymes into the matrix, their activity can speed up its degradation, for example while it resides in a waste facility or landfill. Methods for incorporating enzymes into the matrix can include physical adsorption, covalent binding, crosslinking, and encapsulation. Additionally, enzymes can be immobilized onto particles and then incorporated into the existing matrix for better retention and distribution. Moreover, enzyme loading and enzyme selection can be adjusted to speed up or slow down the rate of degradation under different circumstances. For example, enzymes that are active in specific temperature ranges and pH environments can be selected to initiate degradation when the material ends up in home compost or soil, or instead when the material is intended for a more delayed degradation process when it is consigned to a landfill.

Ultraviolet (UV) resistance can also be imparted to the existing matrix or the composite NCE-containing matrix with additives that absorb or stabilize UV radiation. For example, carbon black or other dyes that absorb UV light can be added as pigments. In embodiments, lignin, a bio-based material that contains different UV functional groups including phenolic units, ketones, chromophores, and conjugated double bonds that can impart UV resistance, can be incorporated as a UV absorbing additive into the polymer matrix to enhance long term stability. In embodiments, lignin can be combined with the NCE-containing matrix for in articles of manufacture (e.g., sunglass frames) that are commonly exposed to UV rays.

In embodiments, the existing matrix or the composite NCE-containing matrix can be magnetized with additives such as gamma ferric oxide. While the additives are described above as being added to the existing matrix, it is understood that they can be introduced directly into the composite matrix formulation (i.e., after the additive NCEs are combined with the existing matrix) in addition to or instead of introducing them into the existing matrix.

In an embodiment, a composite NCE-containing matrix for use in a composite NCE-containing material can be prepared as follows. In this embodiment, the bio-based existing matrix is prepared to include performance-enhancing additives, and this existing matrix is then combined with the redispersible or redispersed (additive) NCEs. In an embodiment, to prepare the bio-based existing matrix, the matrix-forming ingredients are dissolved in a solution of acetone or water dependent on the matrix's solubility parameters to form a solution containing about 1 wt % to about 25 wt %, about 5 wt % to about 15 wt %, about 5 wt % to about 50 wt %, or about 20 wt % to about 75 wt % of those ingredients, for example, a 12 wt % solution of those ingredients. Matrix-forming ingredients can include constitutive polymer ingredients (e.g., cellulose acetate (CA), cellulose acetate butyrate (CAB), or the like, and other cellulose ethers such as methyl cellulose, carboxymethyl cellulose, hydroxypropyl cellulose, carboxymethyl cellulose, sodium carboxymethyl cellulose, hydroxymethyl cellulose, and the like, polydroxyalkanoates (PHAs) such as poly-3-hydroxybutyrate (PHB), polyhydroxyvalerate (PHV), polygydroxyhexanoate (PHH), polybutylene succinate (PBS), and the like, or combinations of such polymer ingredients) can be combined with plasticizers (e.g., triacetin, triethyl citrate, acetyl triethyl citrate, glycerol, xylitol, trehalose, sorbitol, mannitol, polyethylene glycol, polypropylene glycol, epoxidized soybean oil, castor oil, palm oil, and the like), along with rosin or derivatives thereof, fillers such as calcium carbonate or silica, bulking agents such as pulp or pulp-based materials, and/or fatty acids (preferably saturated) such stearic acid, lauric acid, palmitic acid, oleic acid, and the like. As an example, the CAB or other biopolymer can be added in a range from about 60% to about 90%; the plasticizer can be added in a range from about 0.1% to about 20%; the gum rosin can be added in a range from about 5% to about 50%. As another example, the CAB or other biopolymer can be added in a range from about 55% to about 95%; the plasticizer can be added in a range from about 0.1% to about 20%; stearic acid can be added in a range from about 5% to about 25%, and calcium carbonate can be added in a range from about 0.5% to about 17%, with the ratio of stearic acid to calcium carbonate at about 3:2. In another example, HPC or other biopolymer can be added in a range from about 20% to about 95%; the plasticizer can be added in a range from about 5% to about 40%, the gum rosin can be added in a range from about 5% to about 50%. As yet another example, HPC or other biopolymer can be added in a range from about 5 to about 50%; the plasticizer can be added in a range from about 0.5% to about 30%.

For example, ingredients including rosin, a plasticizer, and cellulose acetate butyrate (or any other biopolymer or combination of biopolymers) are combined along with other additives; under certain circumstances the order of combination can matter. In embodiments, the least viscous ingredients are combined first (rosin, PCC, stearic acid), with subsequent addition of the CAB, followed by addition of the plasticizer. The solution is stirred until the mixture is homogeneous and no clumps remain. This solution thickens to provide the existing matrix into which the additive NCEs are to be incorporated.

In parallel, the additive NCEs are prepared. In an embodiment, a selected amount of dried, redispersible NC-containing material prepared as described above is resuspended in a resuspending fluid such as water, mixing thoroughly with an overhead mixer.

In this way a formulation of redispersed additive NCEs is produced. In an embodiment, a formulation of redispersed NCEs can contain an amount of redispersed NCEs suitable to achieve the desired properties in the composite NCE-containing material. An amount of redispersed NCEs ranging from about 1% to about 50% (wt %) of the entire composite NCE-containing matrix can be used, with a range from about 5% to about 40% being advantageous. Using less water for this formulation will facilitate the drying of the material into which the additive NCEs are to be incorporated, assisting with its moldability. This formulation of additive NCEs is then combined with the existing matrix to produce the composite NCE-containing matrix. In this embodiment, no further ingredients are added to the composite NCE-containing matrix, since the appropriate ingredients have been added to the existing matrix already. A surfactant such as capryl glycoside can be added; without being bound by theory, it is understood that such an additive can bridge polar and non-polar components during mixing and processing. The composite NCE-containing matrix and any other desired ingredients can then be mixed under high shear by an overhead stirrer, a high shear mixer, a twin-screw extruder, and the like, to yield the composite NCE-containing material. This initial forming process can be adjusted based on the viscosity requirements for the manufacturing process being used to produce the formed article from the composite NCE-containing material.

### 4. Foamed Articles of Manufacture

a. Foaming Methods for NCE-Based and NCE-Containing Materials

In an illustrative embodiment, a foaming formulation can be prepared as follows. First, a population of NCEs can be treated to permit redispersibility and can optionally be dried in some capacity and redispersed, or can be used undried in their aqueous form, all as described above. Next, an unsaturated, saturated, or supersaturated solution of a cellulosic polymer (such as, but not limited to, MC (methyl cellulose), CMC (carboxymethyl cellulose), CMCNa (sodium carboxymethyl cellulose salt), CA (cellulose acetate), CDA (Cellulose diacetate), CTA (cellulose triacetate), CAB (cellulose acetate butyrate), CAPh (cellulose acetate phthalate), CAP (cellulose acetate propionate), EC (ethyl cellulose), HEC (hydroxyethyl cellulose), EHEC (ethyl hydroxyethyl cellulose), HPC (hydroxypropyl cellulose), HPMC (hydroxypropyl methylcellulose), HPMCP (hydroxypropyl methylcellulose phthalate), HPMCAS (hydroxypropyl methylcellulose acetate)) is prepared in its proper solvent, with the optional addition of a plasticizer. Depending on the cellulosic polymer selected, an appropriate plasticizer can be a polyol (e.g., glycerol, xylitol, diglycerol), a fatty acid (e.g., oleic acid), triacetin, triethyl citrate, acetyl triethyl citrate, tributyl citrate, diethyl phthalate, dibutyl phthalate, dioctyl phthalate, levulinic acid, PEG, polysorbate, or any blocking agent to reduce physical or chemical interaction, such as hydrogen bonding). The redispersible NCEs can be added to this solution in the state of their aqueous formulation before drying, or in a dry state, or they can be redispersed as a slurry of 1-10% NCEs before adding. When the cellulosic polymer solution, and redispersible NCE slurry are not miscible, a small amount of dispersant aid, such as but not limited to, a surfactant (e.g., capryl glucoside) can be added to encourage homogenization of the mixture. Pentane, often mixed with ethanol, is added to the solution as the blowing agent.

Foaming can be produced easily in such mixtures because of their high viscosity. Thus, the addition of viscosifiers or thickeners provide phase interface stabilization, can cause crosslinking, and increase the elasticity of the sample. Exemplary thickeners include, without limitation, gums such as xanthan, guar, agar, locust bean, tamarind, acacia, gellan, welan, carrageenan, and the like. Given the interfacial stabilization, the mixture will respond to foam-forming processes such as vigorous agitation or whipping or by other methods familiar in the art, and barrier properties can be readily introduced into the foam. Adding foam-forming substances such as surfactants to the mixture prior to or during the foam-forming process can facilitate foaming due to their ability to stabilize phase interfaces.

The foam-forming mixture can optionally be combined with a barrier-producing formulation, as described previously. In embodiments, a hydrophobic barrier-producing formulation comprising agents such as surface modified NCEs, mono-, di-, or tri-acetate, (CA) and its derivatives, oils, resinous materials, waxy materials, proteins, lignin and its derivatives, lignocellulosics; without limitation, examples include resin, rosin, beeswax, carnauba wax, zein, pea protein, and the like can be employed. In embodiments, an oleophobic barrier-producing formulation comprising agents such as NCEs (in a variety of aspect ratios and sizes), surface-modified NCEs, lignin-containing NCEs, CA and its derivatives, lignin and its derivatives, MC, pulp, wood flour, chitosan, silicone dioxide, calcium carbonate, calcium carbonate coated with stearic acid, and the like, can be employed. A barrier-producing formulation, for example comprising a hydrophobic starch, a hydrophobic cellulosic polymer, a fatty acid, surfactant, or an oil-in-water resin or wax emulsion, can be added in ratios ranging from 1:3 barrier additive to NCE to 15:1 barrier additive to NCE dry weight, and preferably from 3:1 to 9:1, in order to produce desired barrier properties. In certain embodiments, the barrier-producing formulation can act as a substitute for the cellulosic polymer or can work in tandem with it, while in yet other embodiments, the cellulosic polymer itself can provide the desired hydrophobicity or oleophobicity.

In more detail, barrier-producing formulations for use with the foaming formulations disclosed herein can be prepared to emphasize OGR properties or WVR properties or both; in embodiments, barrier-producing formulations can include both types of properties, and the formulation components can be tuned to accentuate either the OGR or the WVR properties or to balance them. For example, a range of cellulosic polymers exists, with the various polymers having different degrees of hydrophobicity or oleophobicity, so that a cellulosic polymer can be selected to produce the desired degree of OGR and/or WVR. Barrier-producing formulations to produce water resistance may include a variety of cellulose-based polymers, and specifically ones that are more hydrophobic. Overall, cellulose-based polymers tend to be oleophobic (hydrophilic), so it can be beneficial to include other materials in a barrier-producing formulations if more water resistance is desired. For example, methyl cellulose provides good oil/grease resistance, but not as much water-resistance. A mixture of methyl cellulose (MC) and cellulose acetate (CA) can be provided to tune for both OGR and WVR properties. LCST polymers discussed work well for oil resistance, but the films/coatings created with them are soluble at room temperature, causing their water resistance properties to be less efficient. Cellulose acetate and lipids are some examples of additives that can be used to tune barrier-producing formulations to be more hydrophobic, and the combination of this component with a more oleophobic material can provide both oil and water resistance. Cellulose acetate, notably, can provide both hydrophobic and oleophobic properties. Cellulose acetate and other cellulose acetate derivatives (for example, without limitation cellulose acetate butyrate), are unique in that they also have a degree of oleophobicity, in addition to their strong hydrophobicity. Similarly, certain fillers have more hydrophobic or oleophobic properties: for example, a filler such as wax can be selected to increase hydrophobicity, or, for example, a large surplus of NCEs can be added as pore-blockers to increase oleophobicity. Fatty acids, on their own or paired with charged binder agents such as a mineral (e.g., calcium carbonate paired with stearic acid) may also be used to increase hydrophobicity.

In embodiments, substances such as MC. HPMC, CMC, NaCMC, CA, CAB, chitosan, rosin, lignin, vegetable proteins (such as pea protein, zein, and the like), and/or any combination thereof can be employed as oleophobic substances to provide oil resistance; in embodiments, substances such as MC, CA, CAB, chitosan, rosin, hydrophobized starch, lignin, vegetable proteins (such as pea protein, zein, and the like) and/or any combination thereof can be employed as hydrophobic substances to provide water and/or water vapor resistance.

Once the NCE suspension has been foamed by foam-forming processes such as mechanical agitation and/or heating, with optional activation of a blowing agent, drying methods such as, but not limited to, ordinary baking methods, flash-drying, freeze drying/lyophilization, vacuum drying, microwave drying, extrusion and the like can lock in the foamy texture of the material as the material is dried, and retain that structure as it is further processed into formed sheets or formed articles. After the foaming process is initiated or completed, the foam formulation can be further processed and shaped to yield formed articles of manufacture. As examples, the foam formulation can be extruded as billets and thermoformed into articles such as take-out containers. In more detail, rolling up, steam molding, or vacuum molding sheets of such foamed materials can create thermally insulating and lightweight cups, plates, bowls, food wrappers, takeout containers, or other commercially useful containers or packaging materials that have the added advantage of biodegradability as a bio-based product. As another example, high efficiency, lightweight, thermal insulation can be produced from a dried foamed material, with barrier properties available as optional, customizable features (e.g. highly water soluble, or highly water and steam resistant, oxygen and/or vapor resistant, and/or oil resistant).

In another illustrative embodiments, a formulation for producing an OGWR foamed material from a NCE matrix (either simple or composite) can be produced as follows: 1) a population of NCEs can be treated to permit redispersibility and can optionally be dried in some capacity and redispersed, as described above, or used undried in their aqueous form, either to be used for forming a simple NCE-based matrix or a composite NCE-containing matrix; 2) the aqueous solution of the redispersible or redispersed NCEs can be combined with methylcellulose and/or other cellulosics (cellulose esters, ethers, etc.) and/or with a filler or bulking material (for example, without limitation, softwood pulp, hardwood pulp, long fiber pulp, short fiber pulp, Kraft Pulp, SunBurst Pulp, miscanthus, pulps derived from agricultural waste such as soybean, rice hull, or bagasse, fast growing tree species such as eucalyptus, wood flour, saw dust, ash, shredded recycled plastics, recycled pulp, optionally shredded and soaked in a liquid blowing agent; 3) a non-aqueous, alcohol (e.g. ethanol) or nonpolar solvent (e.g. acetone) based solution of one or more selected resin acids is prepared, optionally including waxes and other plasticizers (e.g. triglyceride such as corn oil), cellulose acetate and/or other cellulosics and foam-forming substances; 4) additives such as non-cellulosic thickeners (gums like xanthan, guar, locust bean, tamarind, gellan, agar, welan, and the like), cellulosic thickeners (MC, CMC, HPMC, and the like) and a nucleation agent (such as, but not limited to, calcium carbonate, SiO2, TiO2, talc, kaolin, calcium sulfate, magnesium hydroxide, calcium tungstate, magnesium oxide, lead oxide, barium oxide, zinc oxide, boron nitride, magnesium carbonate, lead carbonate, zinc carbonate, barium carbonate, calcium silicate, aluminosilicate, carbon black, graphite, alumina, zinc stearate, and calcium metasilicate) can also be added to either solution, 5) ethanol is added to the aqueous solution (to encourage miscibility), and then the alcohol or acetone-based solution are mixed together; 6) fine resin acid particles precipitate out of solution and deposit themselves on the surface of the NCEs, producing desirable OGWR properties; 7) the resulting mixture can be processed by the desired method to be foamed as-is, or it can be dried or concentrated for transportation to an end-user for later reconstitution and foaming. Foamed materials made from this mixture can be further shaped into formed, foamed articles of manufacture. For example, the mixture can be redispersed or diluted to be foamed and shaped as bowls, plates, cups, and the like, either as a simple NCE-based material or as a NCE-containing component to be mixed with existing matrix materials to form composite NCE-containing materials.

Foaming of such a mixture can be performed by a number of methods. In one embodiment, two solutions, one aqueous and one predominantly nonpolar, are produced and combined. In the aqueous solution, redispersible or redispersed NCEs can be combined with any combination of the following ingredients: an additional dosage of one or multiple cellulose derivatives (e.g. methylcellulose), filler materials (e.g. pulp, wood flour), nucleating agents (e.g. PCC), surfactants, compatibilizers (e.g. capryl glucoside, ethanol), thickeners (e.g. xanthan gum, guar gum, pectin), plasticizers (e.g. glycerol), and blowing agents (e.g. pentane). If the blowing agent is immiscible with water, it can be mixed with something in which it, as well as water, is miscible, for example, ethanol or acetone. A mixture of pentane and ethanol can be prepared as a 1:1-1:5 ratio of pentane to ethanol.

Without being bound by theory, it is understood that this aqueous solution is viscous enough to trap very fine air bubbles that have been introduced and suspended throughout the solution of redispersible NCEs and cellulose derivative(s) via medium to high shear mixing. Thus, when the blowing agent is added to the solution, the bubbles from the air and the blowing agent are kinetically arrested by the high viscosity (and slow diffusion) and charged interactions of the mixture. It is further understood that the uniform distribution and size of these bubbles results in more uniform cells, closed or open, in the final foamed product.

The second, predominately nonpolar solution has one or multiple nonpolar solvent (e.g. acetone, ethanol), resin acids (e.g. gum rosin, polymerized rosin, abietic acid) that will solubilize in the chosen solvent(s), and the option to add one or multiple blowing agents (e.g. pentane), surfactants, compatibilizers (e.g. capryl glucoside), nucleating agents (e.g. precipitated calcium carbonate), cellulose derivates—suspended or solubilized (e.g. methylcellulose, hydroxypropyl methyl cellulose, hydroxypropyl cellulose, cellulose acetate, cellulose acetate butyrate), thickeners (e.g. xanthan, guar, agar) and plasticizers for the resin acids and/or cellulose derivatives (e.g. corn oil, epoxidized soybean oil, triacetin, glycerol, triacetin, acetyl triethyl citrate). In embodiments, the presence of the capryl glucoside and ethanol/pentane mix in either or both solutions helps homogenization when the two solutions are combined via medium to high shear mixing. Once combined, the foams can be heated or microwaved to exhibit expansion, and then dried (by the desired curing methods, examples of which are listed above) to lock in the foamed open or closed celled structure.

In another embodiment, rosin or resin acids are in a mixture a non-polar solvent (ethanol, acetone, methane, and the like) and n-pentane. Other additives, such as one or multiple cellulose derivatives, and a plasticizer, are mixed in. This solution is then mixed with a dried or concentrated mixture of redispersed/redispersible NCEs, and the other potential aforementioned ingredients for the aqueous solution. When the rosin/n-pentane solution is mixed with the aqueous NCE resuspension, the rosin and n-pentane form a particulate emulsion of rosin-coated n-pentane embedded in the NCE-containing matrix. The rosin-covered bubbles of n-pentane expand with heating to inflate the NCE-containing matrix.

In yet another embodiment, a non-polar alcohol-based solution is prepared containing rosin or resin acids, stearic acid or other fatty acids, methylcellulose or other cellulose derivative, and a plasticizer such as corn oil. Separately, an aqueous solution is prepared containing a bicarbonate or other foaming agents and the redispersed/redispersible NCEs. The two solutions are combined via high-RPM whisking. Chemical foaming begins when the two mixtures are combined and whisked, but this foaming can be delayed or modulated by adjusting the amount of water in the system and consequently its viscosity. Rate of foaming can also be modified (accelerated) by heating the system. Foaming can be delayed by embedding the bicarbonate foaming agent in molten wax, and crushing the solidified wax-covered bicarbonate before adding it to the solution: under these circumstances, the wax will melt and release the foaming agent into the solution to effect bubble formation. Foaming can also be delayed by adding solid stearic acid to the solution with subsequent heating of the solution so that the stearic acid melts and enters the solution, thereby encountering and reacting with the bicarbonate. In still another embodiment, an aqueous solution of methylcellulose is formed, at high shear, optionally adding ethanol to the solution to speed up the solubilization of the methylcellulose. A blowing agent such as n-pentane can be added to the emulsion. In embodiments, redispersible or redispersed NCEs are added to the MC solution; a blowing agent can also be added. Separately, a fully dissolved solution of rosin or other resin acid(s) in alcohol is prepared. This solution can be directly added to the NCE-containing aqueous mixture at high shear, or can be emulsified in water using a surfactant such as PEG, and then added to the NCE-containing aqueous mixture. To foam this mixture, mechanical energy using mechanical forces such as mixing, whipping, aerating, pressurizing or depressurizing, and the like, and/or heat can be employed, using heat sources such as oven heating (40-150° C.), microwaving, steaming, and the like.

Other orders of addition for the ingredients can be employed. In one practice of the invention, cellulose acetate is dissolved in acetone, with the subsequent addition of stearic acid. Separately, rosin or other resin acid(s), oil as a plasticizer, and acetone are combined. In a third container, a dried or concentrated mixture of redispersed/redispersible NCEs is combined with the bicarbonate in an aqueous suspension. The rosin-containing solution and the NCE-containing mixture are combined, and the cellulose acetate-containing solution is then added in. In another practice of the invention, stearic acid is dissolved in ethanol. Separately, ethanol, rosin or other resin acid(s), a plasticizer such as an oil, and methylcellulose are combined. In a third container, a dried or concentrated mixture of redispersed/redispersible NCEs is combined with the bicarbonate in an aqueous suspension. The rosin-containing solution and the NCE-containing suspension are mixed, and the stearic acid-containing solution is added to that mixture. Additional water can be added if needed to incite the bicarbonate/acid gas-forming reaction, and thickeners (e.g. xanthan, guar, agar, gellan, and the like) can be added to slow the diffusion rate of gas through the sample.

In yet another practice of the invention, an acetone-based solution is loaded with a nucleating agent, then a resin acid (such as gum rosin) and a cellulosic polymer such as cellulose acetate (or CTA, CAB, CAP, or CAPh) are dissolved in the solution, followed by the addition of a blowing agent (e.g. pentane), and either a solution of redispersible NCEs, for example, redispersed NCEs suspended in a resuspending fluid, or dried, shredded, redispersible NCEs. Before the addition of the NCEs, there is the option to add, to either/both solution(s), a surfactant, another cellulose derivative (for example, suspending a water-soluble cellulose derivative in the acetone solution that will thicken upon addition to the potentially aqueous solution of redispersed NCEs), a fatty acid, and/or a thickener (e.g. xanthan gum).

In each case, after the foaming formulation is prepared, it can be heated, for example in an oven such as a convection oven or vacuum oven, at a range of temperatures depending on the formulation (50-120 degrees ° C.) to expand and then solidify the foam, starting the thermosetting process, without getting too hot that the formulation melts, collapses, burns, or thermally degrades. The heat, especially when provided by hot air, will create a solid film on top of the foam. Once this film has set and the sample is mostly but not completely dry, the sample can optionally be microwaved for about 3-120 seconds (depending on wattage and liquid concentrations in the formulation), preferably in a perforated vessel to avoid steam holes/explosions, and then optionally quenched (rapidly cooled) or placed back in the oven to set the expanded structure. Alternatively, the sample could be extruded, microwaved, baked, quenched, and/or sublimated, and any combination thereof—for example, extruded and then baked. Upon heating, a temperature gradient is formed across the sample. Therefore, the high vapor-pressure solvents evaporate faster at the surface, allowing the rosin or resin acid component of the formulation to supersaturate the surface and nucleate there, creating a hydrophobic, sealed outer layer to the solid foam article. For applications where rigorous hydrophobicity is required, an additional spray on coating (of, for example, without limitation, cellulose acetate and rosin) can be added to the sample before or after molding.

In formulations that include fatty acids, these substances can melt upon heating and interact directly with bicarbonate to release CO₂. If the bicarbonate has been embedded in wax, heating can melt the wax and release the bicarbonate, thus starting the gas-forming reaction. CO₂ that is released can become entrapped by the rosin or resin acid(s) in the formulation, or by matrix components including the NCEs, increasing foam volume. As the formulation cools, the viscosity of the rosin increases, solidifying the foam and trapping the CO₂ in the matrix; quenching (with the option, if needed, to sublimate any trapped water) can also achieve this effect.

Both simple NCE-based materials and composite NCE-containing materials can be incorporated in foams that can be used for a wide variety of articles of manufacture, as will be described below in more detail. Foams can be made either from simple NCE-based matrices or from composite NCE-containing matrices, with such matrices being formed from suspensions of redispersible or redispersed NCEs as described above. Either a simple NCE-based matrix or a composite NCE-containing matrix can act as a substrate for foaming, as can a simple NCE-based material or a composite NCE-based material. Substrates for foaming can further be equipped with or combined with other additives that provide advantageous properties such as barrier properties.

As used herein, the term “foam” refers to a multiphase system of dispersed media, comprising gas bubbles distributed in a liquid or a solid matrix, wherein the density of the multiphase system is less than the density of the liquid or solid matrix alone. The term “foaming” refers to the process of making a foam; an article, material, matrix, etc. that is “foamed” comprises a foam and is formed at least in part by foaming. The process of foaming can take place by exposing a material or a matrix to a foam-forming formulation or a foam-forming process. If a precursor for forming a foamed material is itself foamed, the foamed precursor material can impart its foamed characteristics to a subsequent substrate and affect the foaming thereof. For example, a composite NCE-containing matrix can be foamed prior to its encounter with an existing matrix, and can lead to the formation of a foamed composite NCE-containing material. Similarly, an existing matrix can be foamed prior to its encounter with a composite NCE-containing matrix, and can lead to the formation of a foamed composite NCE-containing material. A foamed composite NCE-containing material can also be formed by combining a non-foamed composite NCE-containing matrix with a non-foamed existing matrix, and then exposing that combination to a foam-forming formulation or a foam-forming process. If at least one of the composite NCE-containing matrix, the existing matrix, or the composite NCE material is sufficiently exposed to a foam-forming formulation or a foam-forming process, the resulting composite NCE-containing material can be transformed into a foamed composite NCE-containing material.

For the purposes of this disclosure, a reference to a solid foam includes open-cell foams and closed-cell foams. Closed-cell foams are recognized as having particular utility for shock absorption and thermal insulation making them useful for packaging materials and containers and other foam-based articles of manufacture. Open-cell foams are useful in articles used for comfort (cushions, car seats, and the like), and in articles such as sponges used for cleaning. Open cell foams are also useful for sound insulation, as the sound waves can travel into the open cell structure and be absorbed therein. Examples of foam uses include, without limitation, articles of manufacture such as cushioning articles (for indoor and outdoor furniture, mattresses, automotive seats and parts, pillows, pet beds, cat litter, wee wee pads, sponges, foamed soap and laundry sheets, face masks, viscoelastic “memory” foam, padded mats, carpet pads, padding for equipment (e.g., seats for exercise equipment) and the like); construction materials (such as rigid lightweight structural components, sealants, fireproofing, thermal and acoustic insulation, space-fillers, adhesives, and the like); flexible plastics for grips or wrappers; waterproof articles such as surfboards, rigid materials for boat manufacture, water tanks, ice chests, and the like; packaging materials such as shock absorbing packaging inserts, shaped retainers within packages, packaging peanuts or similar items, and packaging wrappers; containers.

To produce a foam in a simple NCE-based material or a composite NCE-containing material, that substrate or its precursor matrix can be exposed to the action of a foam-forming substance, or can be exposed to the action of a foam-forming process, or both. Those substrates that are combined with foam-forming substances or are subjected to foam-forming processes or both, in order to produce a foam are termed “foam-forming formulations.” As used herein, the term “foam-forming substance” refers to a chemical substance that carries out the foaming process for a foam-foaming formulation, facilitates the foaming process, or improves the quality of the foam that is formed from the foam-forming formulation. As used herein, the term “foam-forming process” refers to activities such as heating or mechanical whipping that carry out the foaming process for a foam-forming formulation, facilitate the foaming process, or improves the quality of the foam that is formed from the foam-forming formulation. Exposing the simple NCE-based material or composite NCE-containing material to the action of the foam-forming substance or the foam-forming process produces the foaming of such material, yielding a foamed NCE-based or NCE-containing material which can be formed or shaped to produce an article of manufacture, for example by forming or shaping it into a desired configuration.

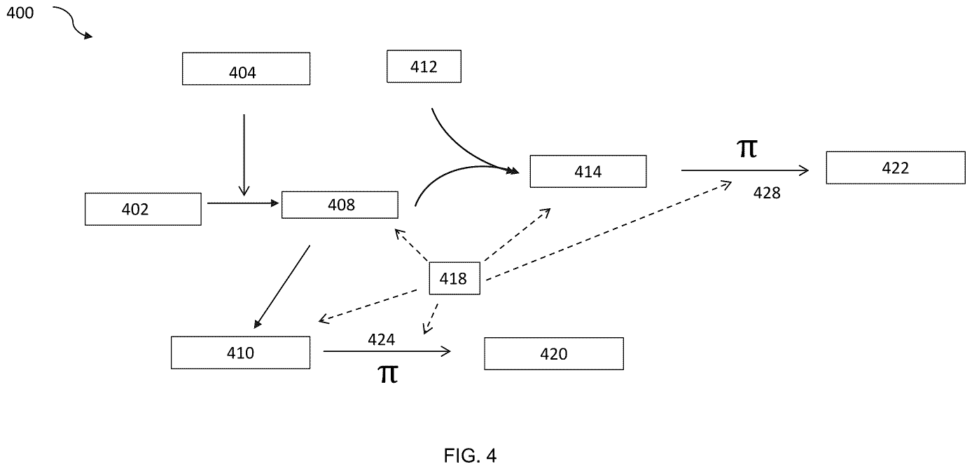

An exemplary process for forming a foamed material from a simple NCE-based matrix or a composite NCE containing matrix is shown schematically in the block diagram of FIG. 4. The process 400 in FIG. 4 begins with providing a dried material 402 containing redispersible NCEs, where such dried material has been prepared substantially as described in connection with FIG. 1. The dried material 402 is then treated with a resuspending fluid 404 to resuspend the NCEs contained in the dried material 402 to form a suspension 408 of redispersed NCEs, substantially as described in connection with FIG. 1. The suspension 408 of redispersed NCEs can then be processed as a simple NCE-based matrix 410, or can be combined with an existing matrix 412 to form a composite NCE-containing matrix 414, substantially as described above in connection with FIG. 2 and FIG. 3.

Foam-forming substances 418 can be added to any of these substances (the suspension 408 of redispersed NCEs, the simple NCE-based matrix 410, or the composite NCE-containing matrix 414) in order to initiate foam forming within the substance, or in order to prepare the substance for further foam-forming processes. Foam-forming substances are familiar in the field, and can include, without limitation: surfactants (nonionic, anionic, cationic, amphoteric) and chemicals that reduce the surface tension of the medium, thus reducing the work needed to create the foam. Foam-forming substances agents include, without limitation, chemicals such as glucosides (e.g. capryl, caprylic, lauryl, coco, decyl, etc.) which also help homogenize polar and nonpolar solutions, SLS (sodium lauryl sarcosinate), SCI (sodium cocoyl isethionate), SDS (sodium dodecyl sulfate), SMCT (sodium methyl cocoyl taurate), SOS (sodium cocoyl sulfate), SCS (sodium caprylyl sulfonate).

In embodiments, foam-forming substances can include gas-producing reagents which form gas that is then trapped within the supporting medium for the foam; this gas trapping creates the foam. Such reagents can decompose or vaporize easily at given temperatures to produce gases or vapors. In other embodiments, foam-forming substances can include two-reactant systems in which two reactants combine to yield a gaseous product; typically, one reagent (the gas producer) reacts with another chemical, resulting in the production of CO₂ or another foam-forming gas from the gas producer. When such substances are incorporated into a precursor material for forming a foam, they can be used to produce a closed-cell structure by decomposing within the precursor material and releasing gas bubbles that are trapped during the solidification of the precursor material to form the foam. Such foam-forming substances can be termed blowing agents, specifically chemical blowing agents because they produce gases and foaming through chemical changes or reactions.

Chemical blowing agents such as calcium bicarbonate or sodium bicarbonate are gas-producing reagents that can be added to the foam-forming formulation and exposed to an acidic environment to release CO₂ gas into the supporting medium. Calcium bicarbonate is advantageous because it is environmentally green, and has low solubility in a foam-forming formulation, and thus tends to form numerous and fine gas bubbles when exposed to acid; such bubbles tend to form a closed cell foam that has greater resistance to oil or water incursion. In embodiments, a carboxylic acid can be included in the formulation to provide the acidification needed to release the CO₂ from the gas-producing reagent. Carboxylic acids selected for this purpose can be derived from bio-based sources, such as fatty acids, e.g., stearic acid, oleic acid, and the like. The long aliphatic tail on fatty acids enhances their compatibility with other components of the foaming mixture. Other chemical blowing agents include, without limitation, isocyanate and water, azodicarbonamide, and hydrazine.

In other embodiments, foam-forming substances include inert gases that are introduced under pressure into a precursor material for forming a foam without any chemical change or reactivity: instead, they form a foam by expanding within the precursor material. The resultant diffusion of the inert gas through the precursor material generally produces an open-cell foam as the pressurized gas penetrates the precursor material to reach the outside environment. Such foam-forming substances can also be termed blowing agents, specifically physical blowing agents because are already in their final chemical state as inert gases and they form the foam by expanding within the precursor material as a result of temperature or pressure differentials. Examples of physical blowing agents include, without limitation, H₂O, liquid, carbon dioxide, supercritical carbon dioxide, hydrocarbons (e.g., n-pentane, isopentane, cyclopentane) hydrochlorofluorocarbons, chlorofluorocarbons. A mix of chemical and physical blowing agents can be used to tailor expansion in the foam and to avoid thermal degradation of the system.

As is known in the foam art, blowing agents can be added to or dissolved (temperature and pressure dependent) in a foam-forming formulation to cause bubbles to nucleate, grow, and stabilize therein. The small gaseous pockets created by the blowing agent can then expand under different conditions such as heat or pressure, and can be stabilized with certain additives (e.g. viscosifiers, electrostatic stabilizers) or by kinetically arresting diffusion of the gas with quenching or heat curing. N-pentane is a blowing agent familiar in the foaming field because of its widespread use in forming foamed polystyrene beads. Many other blowing agents are available for use with the formulations disclosed herein that can produce the desired amount of gas bubble expansion at the desired temperature for foaming.

As shown in FIG. 4, the simple NCE-based matrix 410 and the composite NCE-containing matrix 414 can be further processed to produce, respectively, a simple NCE-based material 420 or a composite NCE-containing material 422. As was previously described in connection with FIG. 1, a simple NCE-based material 420 is understood to comprise a simple NCE-based matrix 410, wherein the simple NCE-based matrix 410 provides the architectural framework for the material, and to further comprise any other additive substances. Similarly, as was previously described in connection with FIG. 1, a composite NCE-containing material 422 is understood to comprise a composite NCE-containing matrix 414, wherein the composite NCE-containing matrix 414 provides the architectural framework for the material, and to further comprise any other additive substances. As shown in FIG. 4, either matrices alone or materials formed therefrom can act as substrates for foaming.

Specifically, as mentioned above, FIG. 4 shows foam-forming substances 418 being optionally introduced into the suspension 408 of redispersed NCEs, and/or into the simple NCE-based matrix 410, where the presence of these additives can initiate foaming or prepare the substance for further foam-foaming processes; FIG. 4 further shows foam-forming substances 418 being optionally introduced as the simple NCE-based matrix 410 is processed to form the simple NCE-based material 420, and as the composite NCE-containing matrix 414 is processed to form the composite NCE-containing material 422; FIG. 4 also shows foam-forming substances 418 being optionally introduced into the composite NCE-based matrix 414. Also optionally, but not shown in FIG. 4, foam-forming substances can be introduced into the existing matrix 412. The Figure depicts the transition from matrix to material as a strategic site for foaming, either as part of the processing step 424 from simple NCE-based matrix to simple NCE-based material, or as part of the processing step 428 from composite NCE-containing matrix to composite NCE-containing material.

Besides these options for foaming due to the action of the foam-forming substances, foaming can also be produced in a simple NCE-based material matrix or material or a composite NCE-containing matrix or material by the action of foam-forming processes in addition to or as an alternative to the action of foam-forming substances. Sites for preferred action of foam-forming processes for producing foams are indicated in FIG. 4 by the symbol π. Foam-forming processes include, without limitation: high RPM mixing (“whipping”) or lower RPM mixing (“stirring”) to physically incorporate air; high to low pressure extrusion; sublimation; exposure to electromagnetic radiation (such as microwaves) to create pores from exciting solvent molecules; and time- and temperature-dependent heating, quenching, and/or freeze drying. These methods can be combined and/or cycled through to achieve the desired foam consistency, density, stiffness, and pore size. In embodiments, mechanical methods are especially advantageous as one of the later stages of the process 400 shown in FIG. 4.

As mentioned previously, plasticizers, filler particles, film-forming biopolymers, and other additives can be added to the NCE matrices (either simple or composite) to form analogous materials (either simple or composite). For those materials intended for foaming, additives can be selected that are compatible with the formation and maintenance of the foam.

Examples of Such Reagents Include, without Limitation:
Fatty acids (e.g., stearic acid)
Alcohols, e.g., methanol and ethanol
Acetone
Resin acids
Natural resins such as camphor, turpentine, dammar gum, shellac and the like
Fat-soluble vitamins (A, D, E, K)
Mineral powders such as titanium dioxide, talcum powder, calcium carbonate, silica, titanium dioxide, and the like
Starches such as corn starch
Selected rubbers and elastomers
   b. Exemplary Foamed Articles of Manufacture

The omnipresence of foam products provides a wide range of other opportunities for substituting foam substrates comprising NCEs as described herein for the conventional petroleum-derived foams that are currently employed. In view of the environmental challenges that accompany the production of conventional petroleum-derived foams and the disposal thereof, the substrates for foaming comprising NCEs as disclosed herein offer welcome alternatives.

Appropriately engineered simple NCE-based or composite NCE-containing matrices or materials can be readily transformed into liquid foams that can be dried to form substitutes for conventional articles such as packaging materials (e.g., paper packaging or packing peanuts) or Styrofoam. For example, foams formed from simple NCE-based matrices or materials or composite NCE-containing matrices or materials can be used in specialized situations such as insulators where properties such as thermal insulation are advantageous, or where the light weight per unit of volume is advantageous, as in packing peanuts. In embodiments, barrier properties can be introduced into the foam using the techniques for rendering the formulation more hydrophobic or oleophobic, as described above. In embodiments, oil and grease resistant properties can be imparted to the foam by rendering some or all of the NCE particles more oleophobic, and/or by preparing a composite NCE-containing matrix having oleophobic properties, or by introducing oleophobic barrier-producing formulations into an appropriate NCE-based/NCE-containing matrix or material; similarly, water resistant properties can be imparted to the foam by rendering some or all of the NCE particles more hydrophobic, and/or by preparing a composite NCE-containing matrix having hydrophobic properties, or by introducing hydrophobic barrier-producing formulations into an appropriate NCE-based/NCE-containing matrix or material. As described herein, foamed formulations can be customized to emphasize either the oleophobic or hydrophobic properties, and foamed formulations can be tuned to exhibit both types of properties to greater or lesser degrees.

Appropriately engineered materials comprising NCE matrices as disclosed herein can offer replacements for conventional foam products such as are found in synthetic Styrofoam packaging materials. Conventional packaging materials and containers are lightweight, cushioning, and water-repelling, thus well-adapted for their end-uses; however, these materials are made from petroleum-based plastics like polystyrene, which, as discussed above, cannot be recycled and which therefore are relegated to landfills, where they take centuries to decompose. Foamed NCE materials (either simple or composite) can offer biodegradable alternatives with good intrinsic mechanical properties to such conventional products.

Composite NCE-containing materials that are foamed offer a bio-based alternative to conventional molded foam for athletic and personal protective articles, such as padding and helmets, to provide support and comfort for the wearer. As an example, foamed soles for athletic shoes can be made from composite NCE-containing materials in order to reduce the amount of materials such as ethyl vinyl acetate and polyurethane and silicone gels used in the shoes, thus offering a more environmentally friendly product. The amount of NCEs can be tuned to improve the bend-twist-tear resistance of the shoe sole, while keeping it lightweight and shape-holding. As an added benefit, viscoelastic dampening can be imparted by the foamed material used as a shoe sole, interrupting the transfer of physical shockwaves through the sole and into the wearer's body with foam cells, optionally complemented by other additives such as small, rigid fibers to absorb parts of the physical force.

Composite NCE-containing matrices that are foamed can provide environmentally conscious substitutes for the synthetic materials used in aquatic recreational articles such as surfboards and boat hulls, replacing fiberglass resins, polyurethane or polystyrene foam cores (surfboards), carbon fiber, fiberglass, polyethylene (sculls), retaining strength with less weight. Composites containing redispersible NCEs can be used to create lightweight, foamed bio-based versions of similar materials.

Advantageously, foamed materials containing redispersible or redispersed NCEs as disclosed herein can be engineered to be less dense than water, so that they float. Foamed articles that float can be designed for special uses in which their ability to float is a significant factor in their utility. A bio-based foamed product can be used in waterways to deliver active agents to the water while floating on its surface. Such a product can be tuned so that it biodegrades after a specified period of time, so that it does not leave residue or plastic waste material on or in the water. For example, a biobased floating foamed product can act as a delivery vehicle for aquatic treatments (e.g., to combat algae blooms or other unwanted species that invade a waterway); after delivering the treatment, the biobased floating foamed article biodegrades. As another example, a biobased floating foamed article can be used to cover the surface of a waterway temporarily to act as a reflector for heat or sunlight. Such a product can be light in color (therefore reflective) or can be embedded with reflective agents that repel heat or sunlight. As yet another example, a biobased floating foamed article can be used as a carrier for agents intended to absorb pollutants from the atmosphere, and can be designed to biodegrade when the agents have become sufficiently saturated with the pollutant. For example, a biobased floating foamed article can be embedded with olivine, a mineral capable of absorbing/adsorbing CO₂ from the atmosphere, and can be deployed to lie on top of an aquatic surface as a sheet, as a series of contiguous or non-contiguous sheets, as sprayable or otherwise dispersible particles. A flotilla of floating foamed particles carrying embedded olivine can be deployed to cover a large surface area of water to absorb large quantities of CO₂. Such particles can be engineered so that they biodegrade when the olivine becomes saturated, so that the olivine-CO₂ complex sinks to the bottom of the waterway and harmlessly captures and retains the CO₂ there. Simple NCE-based materials can be used for this purpose if their limited longevity and durability is not a significant factor. However, if a longer lifespan for the floating foamed particles is desired, composite NCE-containing materials can offer advantages.

Simple NCE-based materials and composite NCE-containing materials have specific mechanical properties due to their incorporation of the NCEs themselves in a structural framework. In embodiments, such foamed materials can be engineered to dissolve at a specific rate to produce a timed release of an active agent embedded in the material or enveloped by it. Such a material can be primed for a particular release profile, for example, by decreasing crystallinity of the foam (lower crystallinity corresponds to faster dissolution), using limited or no hydrophobic additives, and optimizing the plasticizer concentration at higher levels to promote faster dissolution (higher concentration leads to faster dissolution). Foams, as compared to bulk materials, are also likely to dissolve faster since more surface area is exposed, allowing foams advantages in contexts where dissolvability is desired.

The capacity for dissolvability is especially useful in combination with active agents intended for special purposes. Examples of such active agents include agricultural agents, pharmaceutical agents, personal care agents, and the like. Dissolvability allows foamed containers to be constructed for more time-limited ephemeral purposes as containers or carriers. For example, a dissolvable container used as a carrier can deliver the active agent to the target site, and then dissolve when its utility has expired. In embodiments, the NCE-containing foamed substance can be engineered to have more or less biological durability, depending on the envisioned application. Certain foams can be designed to dissolve fairly rapidly, while others remain in place over a longer duration. The former type of foam can be useful for delivery of fertilizers, seeds, pesticides, or other agricultural products or active agents, wherein the container is intended to dissolve over a short period of time in order to release its payload into the environment; such a foam can also serve as a carrier for cosmetic products or medical/veterinary active agents, wherein it is desirable to have the container dissolve after the product or active agent is delivered. The latter type of foam can be engineered to achieve structural stability, for example as a template for orthopedic reconstruction that dissolves gradually as bone regeneration takes place; such a foam can contain and deliver active agents such as hormones, cells, or pharmaceutical agents supporting bone growth, such as, without limitation bone morphogenetic proteins (BMP-2-BMP-4 and BMP-7), insulin-like growth factor, fibroblast growth factor (FGF), vascular growth factor (VEGF), platelet-derived growth factor (PDGF), and mesenchymal stem cells, and the like. In this situation, the foam acts as a container for delivery of the active agents, and is intended to dissolve gradually as the bone heals. As an example, a foamed NCE matrix, optionally combined with materials such as hydroxyapatite, can provide a strong bone graft that can act as a scaffold for osteoblasts to inhabit to produce bone tissue.

As mentioned earlier, the term “container” is to be construed broadly. Tuning the mechanical and barrier properties of those materials used to form foams allows the formed foam articles to be used to containers that have sufficient durability to retain their contents during consumer use, but furthermore to allow for their ready decomposition and biodegradability after use. In the agricultural context for example, the foamed container (for example, a sprayed-on foam) can be used to deliver the payload (for example, an agricultural product such as seeds or an agricultural active agent) to the desired target area (for example, the soil or the surface of a plant). Similarly, a dissolvable foam can be used as a carrier or delivery vehicle for a pharmaceutical active agent in medical or veterinary settings, wherein the foamed container can be used to deliver the payload to the desired internal or external target area. Foams used in the medical or veterinary context can be engineered to permit delayed release or sustained release of desirable treatment agents, with targeting to specific areas requiring treatment and/or with the release of the treatment agent systemically. In yet other settings, dissolvable foam containers can carry active agents within them. The aforementioned active agents can be intended for conveying and releasing substances such as skin nutrients, cosmetics, fragrances, enzymes, insecticides, insect repellents, fertilizers, seeds, mushroom spores, cleaning agents, topical or ingestible medications, topical nutraceuticals or wellness treatments for consumer use, and the like.

In either case, the NCE-containing material, whether it is a matrix formed predominantly from the NCEs or whether it is a composite containing NCEs as an additive to another substrate, can be mixed, aerated, or treated otherwise to create a foam. Components of the foam-forming formulations disclosed herein include the redispersible or redispersed NCEs with or without other matrix materials, and can include a foaming or blowing agent, with or without undergoing a foam-forming process. Foam-forming processes include, without limitation, heating the formulation, changing pressurization, sublimation, mechanical whipping, and the like. Active agents can be optionally added for special purposes, as described below. Performance-altering additives, e.g., for imparting oil, grease, and water resistance, can be incorporated as barrier treatments, as described below. The mixture of redispersible or redispersed NCEs, active agents and performance-altering additives can then be mixed vigorously; in embodiments, sufficient mixing can be applied so that the mixture is aerated into a foam.

In embodiments, a composite matrix produced using biodegradable materials as the existing matrix is especially suitable for foaming and for producing foamed articles of manufacture. Conventional foamed products made from biodegradable materials, for example foams formed from starches, typically have poor performance relative to petroleum-derived foams, often lacking the strength and water/grease resistance of petroleum-derived products. NCE-based foams, derived predominantly from NCE matrices can act as substitutes for conventional foams for uses in common articles of manufacture such as containers and packaging materials, as described above. Composite materials, comprising mixtures of NCEs and biodegradable materials such as starches or derivatized cellulose (e.g., cellulose ethers or cellulose acetate), can also be prepared as foamed articles and can be similarly used as substitutes for conventional foams, combining the advantages of biodegradability with the desirable strength, shock absorbency, light weight, and water resistance that consumer articles such as packaging materials and containers require.

For composite NCE-containing materials comprising starch as the existing matrix, cellulose microfibers are advantageous, either alone or in combination with cellulose nanofibers. Composite materials can also comprise pulp-based matrices or starch-pulp matrices, forming all-cellulose composite NCE-containing materials. Foaming of composite matrices incorporating NCEs can be produced by a number of methods familiar in the art and previously described, such as mechanical foaming techniques, by incorporating foam-forming elements such as surfactants or blowing agents in the mixture. As an example, bicarbonate crystals can also be incorporated into the mixture as a foam forming element with a later addition of acid to activate foaming. Additives such as linseed oil or more hydrophobic cellulose additives, such as methyl cellulose, cellulose acetate, lipids, polyvinyl alcohol or copolymers of polyvinyl acetate/polyvinyl alcohol, waxes, wax emulsions hydrophobic starch, fatty acids, resins, other hydrophobic cellulosic polymers, or any other similar hydrophobic polymers can be added to improve hydrophobicity; alternatively or in addition, the NCE additives can be prepared having OGR properties In some embodiments, chitosan and aluminum sulfate is used to enhance OGR. In other embodiments, celluloses and cellulose derived materials with high hydroxyl content can be used for OGR. To tune the mechanical properties of the foam, additives such as, but not limited to, plasticizers (for example, but not limited to, polyols like glycerol) viscosifiers or thickeners (e.g. xanthan gum, guar gum, and the like), flame retardants (for example, without limitation, metal hydroxides such as Aluminum trihydrate (ATH) and magnesium hydroxide, halogenated compounds (brominated species allow resins to retain their mechanical properties), and polydopamine), nucleating agents such as but not limited to minerals (e.g. precipitate calcium carbonate, silicone dioxide) to tune foam pore size and density.

The concentration of NCEs in the substrate to be foamed can be adjusted to produce appropriate mechanical properties and barrier properties in the final foamed material. For example, the amount of NCEs in the substrate can be varied to attain a softer foam or a stiffer foam, the former being useful for applications like space fillers, packaging, packing peanuts and the like, and the latter being useful for foams used in more structural applications, such as but not limited to containers, foamed packing inserts for fragile items, and construction foams. While the general range of NCEs in the final substrate is 1-10%, for softer foams and 20%-50% for stiffer foams, a very soft foam such as a packing peanut can include as little as 0.1 wt % and a foam for construction materials can include up to 90 wt %.

### EXAMPLES

### Example 1: Producing Redispersible NCE Sheets

Redispersible NCE sheets were produced by combining drying/dispersal additive with an NCE slurry and then drying it at elevated temperature in an oven. There are various combinations and multiple ratios of additives that can be used to create sheets of dried redispersible NCEs. For this specific example the LCST polymer hydroxypropyl methyl cellulose (HPMC) was used as the dispersal additive in combination with nanofibrillated cellulose (NFC) with a ratio of 5:1 NFC:HPMC. Ingredients were combined in a water solution consisting of 1.25 wt % NFC.

TABLE 3
Ingredients for creating redispersible NFC.

| 3 wt % NFC | Water | HPMC |
|---|---|---|
| 41.67 g (1.25 g dry) | 58.08 | 0.25 g |

First, 0.25 g of HPMC was added to 58.08 g of water in a beaker while stirring at a medium-high speed for about 15 minutes, following which the stir speed was decreased to its lowest setting, with mixing continued until all bubbles on the surface dissipated. After removing the beaker from the stir plate, 41.67 g of 3 wt % L NFC (1.25 g of dry weight NFC) was added. These ingredients were then mixed using an overhead stirrer at 250 rpm for 15 minutes. The fully mixed sample was then scooped onto a silicone mat and spread across the mat evenly, using a doctor blade set to 1.5 mm thickness. The mat with the sample on it was placed in an oven and dried at 60° C. until the sample was fully dried (about 2 hours). The dried sheet was slowly removed from the silicone mat. As a result of these procedures, the previously non-dispersible NFCs were modified with drying/dispersal additives so that they could be redispersed when combined with water. A dried sheet containing such redispersible NFCs was produced by these procedures.

### Example 2: Foaming Redispersed NCEs

### Materials

Valida NCEs
Methylcellulose (MC), Sigma Aldrich
Gum Rosin, Sigma Aldrich
Ethanol, McMaster Carr
Glycerol, Sigma Aldrich
Kraft Pulp, General
Pentane, McMaster Carr

Formulation Preparation: A formulation was prepared according to the following protocols.
1. A redispersible NCE sheet was prepared using the following ratios of ingredients: 3:1 MC:NCEs and 19:1 MC:glycerol, generally following the protocol of Example 1.
2. 1.94 g (in which there is 1.4 g MC, 0.467 g of NCEs, and 0.074 grams of glycerol) of the dried redispersible NCE sheet was shredded, and the shredded solids were resuspended in 50 mL of water, stirring the suspension with a stir bar or overhead mixer.
3. 4 g of kraft pulp was finely shredded in a blender, and added to the aqueous slurry of redispersed NCEs at medium to high shear.
4. In another beaker, 4 g of gum rosin was fully dissolved in 7.5 g of ethanol.
5. In another beaker, a 1:1 mixture was prepared that contained 10 grams of both ethanol and pentane (20 g total). This mixture was added to the aqueous slurry of NCEs and pulp.
6. At high shear, the rosin-ethanol mixture was slowly poured into the aqueous slurry.
7. Once fully mixed, the sample was placed on silicone sheets or molds and baked in the oven at 80 degrees until dry.

### Example 3: Foaming NCE Compositions Having Oil, Grease, and Water Resistance

### Materials

Redispersible NCEs
Methylcellulose, Sigma Aldrich
Gum Rosin, Sigma Aldrich
Ethanol, McMaster Carr
Precipitated calcium carbonate (PCC), Sigma Aldrich
Kraft Pulp, Genera
Pentane, McMaster Carr
4% Pulp Slurry, Dart
Capryl Glucoside
Xanthan Gum, Bob's Red Mill

Formulation Preparation: A formulation was prepared according to the following protocols.
1. Redispersible NCEs were prepared substantially as described in Example 1. Methylcellulose (MC) was combined with the redispersible NCEs in an aqueous solution using tap water, with a 0.56 g redispersible sheet having NCE:MC ratio 5:1, and additional MC added so that the ratio was 1:3 NCE:MC. These ingredients were then combined with an overhead mixer at high shear to produce a formulation comprising redispersed NCEs.
2. Pulp from the 4% pulp solids slurry was then added to the formulation produced in Step 1. The amount of pulp that was used was 100 g of a 4% solids pulp slurry, combined with 100 g of the aqueous solution produced in Step 1. This step yielded a formulation comprising pulp and redispersed NCEs.
3. PCC 1.2 g was added to the formulation of Step 2; capryl glucoside 0.04 g was also added.
4. The mixture from Step 3 was then combined with a premixed 1:1 solution of ethanol and pentane, thereby adding 12 g ethanol and 12 g pentane to produce the final aqueous formulation.
5. In a separate beaker, a nonpolar solution was prepared by combining 20 g of ethanol and 10 g of gum rosin and stirring until fully dissolved, with the following additional ingredients added: 2 g of xanthan gum, and 0.02 g of capryl glucoside gum, and 8 g pentane.
6. The nonpolar solution from Step 5 was then added at high shear to the final aqueous formulation from Step 4, producing a mixture for forming foamed articles.
7. Once fully homogenized, the mixture from Step 6 was placed on a perforated silicone sheet or mold and baked in the oven at 80-90 degrees until dry (approximately 3 hours depending on the size and thickness of the sample). It was observed that the wet mixture expanded and dried/set in an expanded foam. This unpressed foam was thermoformed at 200° C. for 8 seconds into the shape of a bowl. It has been observed through this and other experiments that the unpressed foam prepared as disclosed above is suitable for many applications. For example, it can be used for space-filling articles such as packing peanuts. It can also be thermoformed into a variety of formed articles of manufacture.

While this invention has been particularly shown and described with references to preferred embodiments thereof, it will be understood by those skilled in the art that various changes in form and details may be made therein without departing from the scope of the invention encompassed by the appended claims. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference. The relevant teachings of all patents, published applications and references cited herein are incorporated by reference in their entirety.

1. A simple NCE-based material comprising a simple NCE-based matrix,
wherein the simple NCE-based matrix comprises a population of redispersible NCEs treated with a drying/dispersal additive comprising a lower critical solution temperature (LCST) polymer;
wherein the simple NCE-based matrix provides an architectural framework for the simple NCE-based material;
wherein the simple NCE-based material further comprises a barrier formulation; and
wherein the simple NCE-based material is foamed.

2. The simple NCE-based material of claim 1, wherein the barrier formulation comprises a substance selected from the group consisting of cellulosic polymers, lipids, proteins, fillers, fatty acids, a resin acid, and combinations of resin acids.

3. The simple NCE-based material of claim 1, wherein the barrier formulation comprises an oleophobic substance selected from the group consisting of MC, HPMC, CMC, NaCMC, CA, CAB, chitosan, rosin, lignin, and a vegetable protein.

4. The simple NCE-based material of claim 1, wherein the barrier formulation comprises a hydrophobic substance selected from the group consisting of MC, CA, CAB, chitosan, rosin, hydrophobized starch, lignin, and a vegetable protein.

5. The simple NCE-based material of claim 1, further comprising one or more additive substances selected from the group consisting of a bulking agent, a reinforcement agent, a nucleation agent, a plasticizer, a thickener, and an appearance-modifying agent, or a combination thereof.

6. The simple NCE-based material of claim 5, wherein the one or more additive substances is a bulking agent.

7. The simple NCE-based material of claim 6, wherein the bulking agent comprises pulp or a pulp-based substance.

8. The simple NCE-based material of claim 6, wherein the bulking agent comprises filler particles.

9. The simple NCE-based material of claim 8, wherein the filler particles comprise plant-derived organic materials.

10. The simple NCE-based material of claim 5, wherein the one or more additive substances is a nucleation agent.

11. The simple NCE-based material of claim 5, wherein the one or more additive substances is a plasticizer.

12. The simple NCE-based material of claim 11, wherein the plasticizer is selected from the group consisting of glycerol, triglycerin, triacetin, triethyl citrate, acetyl triethyl citrate, tributyl citrate, oleic acid, levulinic acid, PEG, and polysorbate.

13. The simple NCE-based material of claim 5, wherein the one or more additive substances is a thickener.

14. The simple NCE-based material of claim 13, wherein the thickener is selected from the group consisting of xanthan gum, guar gum, agar gum, welan gum, gellan gum, MC, CMC, and HPMC.

15. The simple NCE-based material of claim 1, further comprising a foam-forming substance.

16. An article of manufacture, comprising the simple NCE-based material of claim 1.

17. The article of manufacture of claim 16, wherein the article is shaped into a formed article.

18. The article of manufacture of claim 17, wherein the formed article is shaped as a plate or a bowl.

19. The article of manufacture of claim 17, wherein the formed article is shaped as a floating sheet or a floating particle.

20. A method of manufacturing a foamed article comprising a simple NCE-based material, comprising:
a. producing a simple NCE-based material comprising redispersible NC elements, wherein the simple NCE-based material is produced by the substeps of:
i. providing an initial suspension comprising NC elements suspended in a fluid medium;
ii. combining a drying/dispersal additive with the initial suspension to form a suspension of redispersible NCEs; and
iii. adding an additive substance to the suspension of redispersible NCEs, thereby forming the simple NCE-based material;
b. exposing the simple NCE-based material to the action of a foam-forming substance or a foam-forming process to form a foamed simple NCE-based material;
c. forming or shaping the foamed simple NCE-based material into a desired configuration to provide the foamed article.

21. The method of manufacturing of claim 20, wherein the step of forming or shaping comprises extrusion.

22. A foamed composite NCE-containing material comprising a composite NCE-containing matrix,
wherein the composite NCE-containing matrix comprises a population of redispersible NCEs treated with a drying/dispersal additive comprising a lower critical solution temperature (LCST) polymer, and an existing matrix;
wherein the redispersible NCEs are integrated into the existing matrix, and wherein the existing matrix provides an architectural framework for the composite NCE-containing material;
wherein the composite NCE-containing material comprises a barrier formulation; and wherein at least one of the composite NCE-containing matrix, the existing matrix, or the composite NCE material is exposed to a foam-forming formulation or a foam-forming process whereby the composite NCE-containing material is transformed into a foamed composite NCE-containing material.

23-48. (canceled)
